(19) United States
(12) Patent Application Publication
(10) Pub. No.: US 2022/0335775 A1
(43) Pub. Date: Oct. 20, 2022

(54) ELECTRONIC GAMING DEVICE WITH SKILL-BASED REEL AND RANDOM-EVENT-BASED REELS

(71) Applicant: Aristocrat Technologies, Inc., Las Vegas, NV (US)

(72) Inventors: Bretton Maddux, Henderson, NV (US); Andrew Harrington, Las Vegas, NV (US); Adam Pippin, Las Vegas, NV (US)

(73) Assignee: Aristocrat Technologies, Inc., Las Vegas, NV (US)

(21) Appl. No.: 17/491,299

(22) Filed: Sep. 30, 2021

Related U.S. Application Data
(60) Provisional application No. 63/176,166, filed on Apr. 16, 2021.

(51) Int. Cl. G07F 17/32; G07F 17/34

(52) U.S. Cl. CPC G07F 17/3213; G07F 17/34

(57) ABSTRACT

Innovations in integrating a skill-based selection mechanism and a random number generator (“RNG”)-event-based mechanism in an electronic gaming device are described. For example, an instance of a process of an electronic gaming device uses a set of reels and at least one RNG. The set of reels includes one or more skill-based reels and one or more RNG-event-based reels. For each of the skill-based reel(s), based on user input, a stop position at which to stop a reel strip for the skill-based reel is determined. For each of the RNG-event-based reel(s), a random number is generated using the RNG, and a stop position at which to stop a reel strip for the RNG-event-based reel is determined. Then, based at least in part on instances of symbols in a reel area for the stopped RNG-event-based reel(s), an outcome of the instance of the process is determined.

### RELATED APPLICATION INFORMATION

This application claims the benefit of U.S. Provisional Application No. 63/176,166, filed Apr. 16, 2021, the disclosure of which is hereby incorporated by reference.

### FIELD

User interface (“UI”) features of electronic gaming devices are described herein, along with features of backend processing to implement the UI features. For example, an electronic gaming device with spinning reels includes a mix of one or more skill-based reels and one or more random-event-based reels, which provide computationally effective ways to manage volatility while improving usability and enhancing the user experience.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or pay lines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of pay lines and/or the amount bet on each line. By varying the wager, the player may sometimes alter the frequency or number of winning combinations, frequency or number of secondary games, and/or the amount awarded.

Typical games use a random number generator (“RNG”) to randomly determine the outcome of each game. The game is designed to return a certain percentage of the amount wagered back to the player over the course of many plays or instances of the game, which is generally referred to as return to player (“RTP”). The RTP and randomness of the RNG ensure the fairness of the games and are highly regulated. Upon initiation of play, the RNG randomly determines a game outcome and symbols are then selected which correspond to that outcome.

EGMs depend on usability to enhance the user experience and extend player time on the EGMs. Although previous EGMs include various UI features, and backend operations associated with the UI features, that improve usability and enhance the user experience, there is room for further improvement to EGMs.

### SUMMARY

In summary, the detailed description presents innovations in integrating a skill-based selection mechanism and a random number generator (“RNG”)-event-based mechanism in an electronic gaming device. Some of the innovations relate to integrating a skill-based selection mechanism and an RNG-event-based mechanism in an electronic gaming device that has a set of reels including one or more skill-based reels and one or more RNG-event-based reels. An instance of a process uses the set of reels and at least one RNG. For each of the skill-based reel(s), based on user input, a stop position at which to stop a reel strip for the skill-based reel is determined. For each of the RNG-event-based reel(s), a random number is generated using the RNG, and, based at least in part on the random number, a stop position at which to stop a reel strip for the RNG-event-based reel is determined. Then, based at least in part on instances of symbols in a reel area for the stopped RNG-event-based reel(s), an outcome of the instance of the process is determined. For example, the innovations described herein include, but are not limited to, innovations recited in the claims. This gameplay mechanic, which combines skill-based decisions for the skill-based reels with RNG-event-based aspects, increases user engagement and interaction with the electronic gaming device. These innovations also provide different tools for managing volatility and RTP in a computationally effective way when integrating a skill-based selection mechanism and RNG-event-based mechanism in an electronic gaming device.

The innovations can be implemented as part of a method, as part of an electronic gaming device such as an EGM or electronic gaming server configured to perform the method, or as part of non-transitory computer-readable media storing computer-executable instructions for causing one or more processors in a computer system to perform the method. The various innovations can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures and illustrates a number of examples. Examples may also be capable of other and different applications, and some details may be modified in various respects all without departing from the spirit and scope of the disclosed innovations.

### BRIEF DESCRIPTION OF THE DRAWINGS

FIG. 1 is an exemplary diagram showing several EGMs networked with various gaming related servers.

FIG. 2 is a block diagram showing various functional elements of an exemplary EGM.

FIG. 3 illustrates, in block diagram form, an embodiment of a game processing architecture that implements a game processing pipeline for the play of a game in accordance with various embodiments described herein.

FIGS. 4a-4c are diagrams showing a UI of an electronic gaming device that uses a set of reels including a skill-based reel (for feature selection) and four RNG-event-based reels.

FIGS. 5a-5d are diagrams showing a UI of an electronic gaming device that uses a set of reels including two skill-based reels (for symbol instance selection) and three RNG-event-based reels.

FIGS. 6 and 7a are flowcharts showing example techniques, focusing on frontend operations and backend operations, respectively, for controlling the UI of an electronic gaming device with a set of reels including one or more skill-based reels and one or more RNG-event-based reels. FIG. 7b is flowchart showing an alternative example technique, focusing on backend operations, with different timing of operations.

FIGS. 8 and 9 are flowcharts showing alternative example techniques, focusing on frontend operations and backend operations, respectively, for controlling the UI of an electronic gaming device with a set of reels including one or more skill-based reels and one or more RNG-event-based reels.

FIG. 10a-10d are screenshots showing a display screen of an electronic gaming device that uses a set of reels including a skill-based reel (for feature selection) and four RNG-event-based reels.

### DETAILED DESCRIPTION

The detailed description presents innovations in integrating a skill-based selection mechanism and an RNG-event-based mechanism in an electronic gaming device. For example, some of the innovations relate to integrating a skill-based selection mechanism and an RNG-event-based mechanism in an electronic gaming device with a set of reels including one or more skill-based reels and one or more RNG-event-based reels. An instance of a process uses the set of reels and at least one RNG. For each of the skill-based reel(s), based on user input, a stop position at which to stop a reel strip for the skill-based reel is determined. For each of the RNG-event-based reel(s), a random number is generated using the RNG, and, based at least in part on the random number, a stop position at which to stop a reel strip for the RNG-event-based reel is determined. Then, based at least in part on instances of symbols in a reel area for the stopped RNG-event-based reel(s), an outcome of the instance of the process is determined. These innovations provide different tools for managing volatility and RTP in a computationally effective way, while also improving usability of the electronic gaming device and enhancing the user experience.

In particular, the approaches to using a combination of skill-based reels and RNG-event-based reels provide a computationally effective way to manage volatility for a target level of RTP, while also improving the usability of the electronic gaming device and enhancing the user experience. For additional details about technical advantages, see section V.G.

In the examples described herein, identical reference numbers in different figures indicate an identical component, module, or operation. More generally, various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Some of the innovations described herein address one or more of the problems noted in the background. Typically, a given technique/tool does not solve all such problems. It is to be understood that other examples may be utilized and that structural, logical, software, hardware, and electrical changes may be made without departing from the scope of the disclosure. The following description is, therefore, not to be taken in a limited sense.

### I. EXAMPLE ELECTRONIC GAMING SERVERS AND ELECTRONIC GAMING MACHINES (“EGMS”)

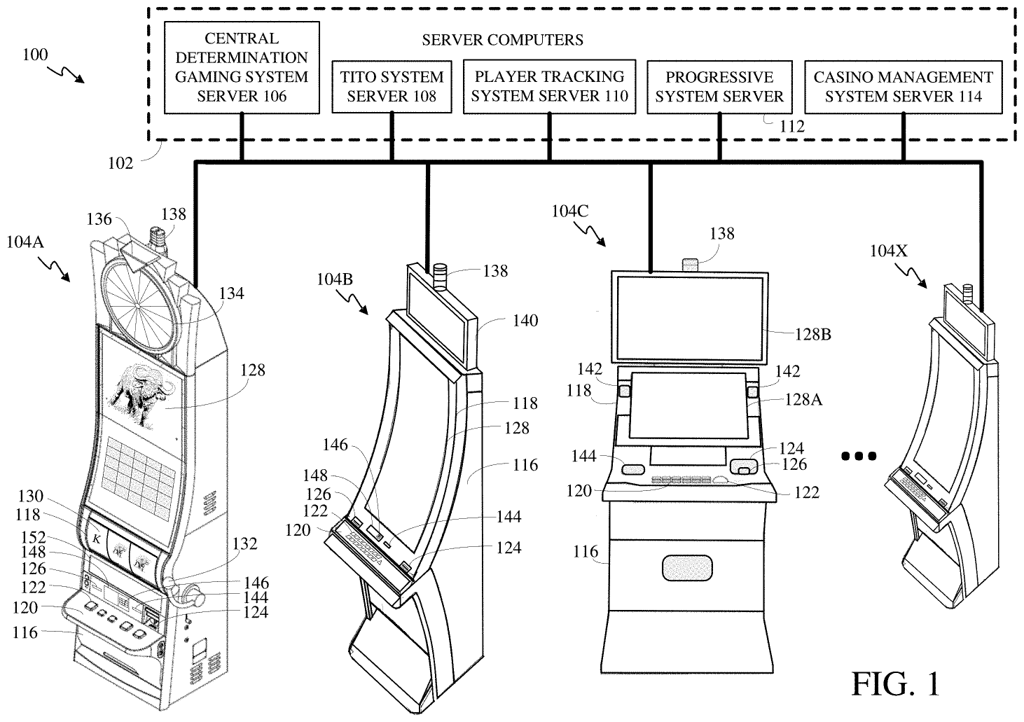

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (“RF”) (e.g., wireless fidelity (WiFi®) and Bluetooth®), cable TV, satellite links and the like.

In some embodiments, server computers 102 may not be necessary and/or preferred. For example, in one or more embodiments, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (“TITO”) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (TITO) system). In such cashless embodiments, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some embodiments, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such embodiments, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

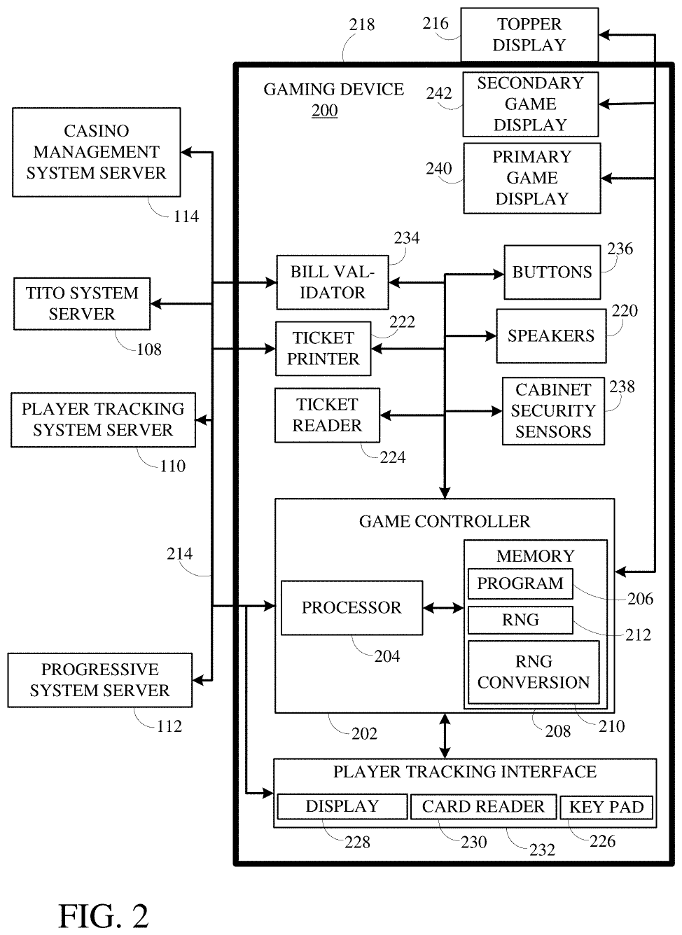

Many or all the above described components can be controlled by circuitry (e.g., a game controller) housed inside the main cabinet 116 of the gaming device 104A, the details of which are shown in FIG. 2.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator. In some embodiments, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of pay lines, maximum jackpot, progressive or non-progressive, bonus games, and may be deployed for operation in Class 2 or Class 3, etc.

FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1. As shown in FIG. 2, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on a chip (SoC) that combines and integrates one or more general-purpose processors and/or one or more specialized processors. Although FIG. 2 illustrates that game controller 202 includes a single processor 204, game controller 202 is not limited to this representation and instead can include multiple processors 204 (e.g., two or more processors).

FIG. 2 illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2 illustrates that game controller 202 includes a single memory 208, game controller 202 could include multiple memories 208 for storing program instructions and/or data.

Memory 208 can store one or more game programs 206 that provide program instructions and/or data for carrying out various embodiments (e.g., game mechanics) described herein. Stated another way, game program 206 represents an executable program stored in any portion or component of memory 208. In one or more embodiments, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be setup to generate one or more game instances based on instructions and/or data that gaming device 200 exchange with one or more remote gaming devices, such as a central determination gaming system server 106 (not shown in FIG. 2 but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2 illustrates that gaming device 200 includes an RNG 212 that utilizes hardware and/or software to generate RNG outcomes that lack any pattern. The RNG operations are often specialized and non-generic in order to comply with regulatory and gaming requirements. For example, in a reel game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more embodiments, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2 illustrates that gaming device 200 includes an RNG conversion engine 210 that translates the RNG outcome from RNG 212 to a game outcome presented to a player. To meet a designated RTP, a game developer can setup the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts. As explained below, a conversion engine (such as the RNG conversion 210) can also account for non-RNG outcomes, which are based on user input, to adapt or select game features.

FIG. 2 also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gamine device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more Uls, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Although FIGS. 1 and 2 illustrates specific embodiments of a gaming device (e.g., gaming devices 104A-104X and 200), the disclosure is not limited to those embodiments shown in FIGS. 1 and 2. For example, not all gaming devices suitable for implementing embodiments of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Additionally, or alternatively, gaming devices 104A-104X and 200 can include credit transceivers that wirelessly communicate (e.g., Bluetooth or other near-field communication technology) with one or more mobile devices to perform credit transactions. As an example, bill validator 234 could contain or be coupled to the credit transceiver that output credits from and/or load credits onto the gaming device 104A by communicating with a player's smartphone (e.g., a digital wallet interface). Gaming devices 104A-104X and 200 may also include other processors that are not separately shown. Using FIG. 2 as an example, gaming device 200 could include display controllers (not shown in FIG. 2) configured to receive video input signals or instructions to display images on game displays 240 and 242. Alternatively, such display controllers may be integrated into the game controller 202. The use and discussion of FIGS. 1 and 2 are examples to facilitate ease of description and explanation.

Those of skill in the art will appreciate that embodiments of the present disclosure could be implemented with more or fewer elements than are depicted in FIG. 2. The pictured example embodiments of a gaming device 200, as well as example gaming devices 104A-C, are merely a few examples from a wide range of possible gaming device designs on which embodiments of the present disclosure may be implemented. Depending on implementation and the type of processing desired, components of the gaming device 200 can be added, omitted, split into multiple components, combined with other components, and/or replaced with like components. In alternative embodiments, gaming devices with different components and/or other configurations of components perform one or more of the described techniques. Specific embodiments of gaming devices typically use a variation or supplemented version of the gaming device 200. The relationships shown between components within the gaming device 200 indicate general flows of information in the gaming device 200; other relationships are not shown for the sake of simplicity. In general, the game controller 202 can be implemented by software executable on a CPU, by software controlling special-purpose hardware, or by special-purpose hardware (e.g., in an ASIC).

### II. EXAMPLE GAME PROCESSING ARCHITECTURES

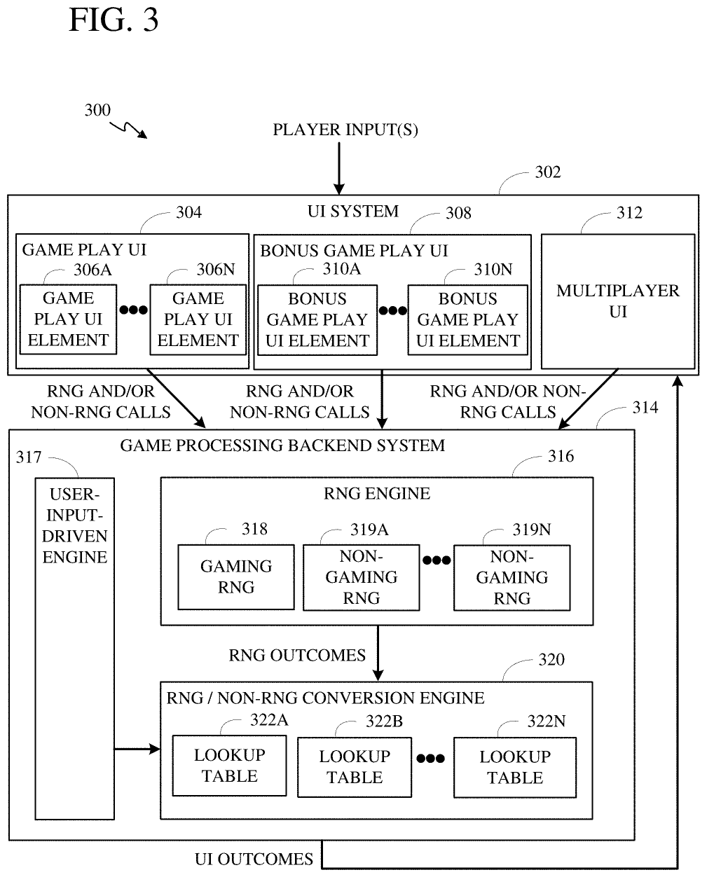

FIG. 3 illustrates, in block diagram form, an embodiment of a game processing architecture 300 that implements a game processing pipeline for the play of a game in accordance with various embodiments described herein. As shown in FIG. 3, the gaming processing pipeline starts with having a UI system 302 receive one or more player inputs for the game instance. Based on the player input(s), the UI system 302 generates and sends one or more RNG calls and/or one or more non-RNG calls to a game processing backend system 314. Game processing backend system 314 then processes the RNG calls with RNG engine 316 to generate one or more RNG outcomes. Game processing backend system 314 processes the non-RNG calls with user-input-driven engine 317 to generate one or more non-RNG outcomes. For example, a non-RNG call can include information about a stop position of a reel, card position, or other UI feature selected by a user for a skill-based mechanism or, more generally, include other information about user input for a skill-based mechanism. The RNG outcomes and non-RNG outcomes are then sent to the RNG/non-RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. For example, the UI elements can include mechanical and/or graphical elements for one or more skill-based mechanisms and one or more RNG-event-based mechanisms. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more embodiments, at least some of the game play UI element 306A-306N are similar to the bonus game play UI elements 310A-310N. In other embodiments, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or present game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls and/or non-RNG calls to a game processing backend system 314. As an example, the UI system 302 could use one or more application programming interfaces (“APIs”) to generate the RNG calls. To process the RNG calls, the RNG engine 316 could utilize gaming RNG 318 and/or non-gaming RNGs 319A-319N. Gaming RNG 318 corresponds to RNG 212 shown in FIG. 2. As previously discussed with reference to FIG. 2, gaming RNG 318 often performs specialized and non-generic operations that comply with regulatory and/or game requirements. For example, because of regulation requirements, gaming RNG 318 could be a cryptographic random or pseudorandom number generator (“PRNG”) (e.g., Fortuna PRNG) that securely produces random numbers for one or more game features. To generate random numbers, gaming RNG 318 could collect random data from various sources of entropy, such as from an operating system (“OS”). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for such as generating random messages that appear on the gaming device.

To process non-RNG calls, the user-input-driven engine 317 maps inputs received for the non-RNG calls to non-RNG outcomes, which are provided to the conversion engine 320. For example, the user-input-driven engine 317 maps information about a stop position for a reel, card position, or other UI element selected by a user for a skill-based mechanism to an outcome for that skill-based mechanism in the context of an instance of a base game or bonus game.

The RNG/non-RNG conversion engine 320 processes each RNG outcome from RNG engine 316 and each non-RNG outcome from the user-input-driven engine 317, and converts the outcomes to a UI outcome that is fed back to the UI system 302. With reference to FIG. 2, conversion engine 320 corresponds to conversion engine 210 used for game play. As previously described, conversion engine 320 translates the RNG outcome from the RNG 212 to a game outcome presented to a player. The conversion engine 320 can use a non-RNG outcome to select a game outcome presented to a player (such as a selection for a skill-based mechanism). In some example implementations, the conversion engine 320 can, based on a non-RNG outcome, adapt how a game outcome is selected using an RNG outcome (e.g., adjusting reel strips, dynamic symbol resolution, or lookup tables to balance overall RTP in view of the non-RNG outcome). RNG/non-RNG conversion engine 320 utilizes one or more lookup tables 322A-322N to regulate a prize payout amount for each RNG outcome and how often the gaming device pays out the derived prize payout amounts. In one example, the conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel, where the reel is an RNG-event-based reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

The example game processing architecture 300 shown in FIG. 3 can be used to process game play instructions and generate outcomes as described in later sections.

### III. REEL GAMES, SUPPLEMENTAL FEATURES, AND OUTCOME DETERMINATIONS

Electronic gaming devices can incorporate the innovations described herein into various types of reel games or other games. A reel game can be a base reel game or bonus reel game. A base, or primary, reel game includes play that involves spinning reels. A bonus, or secondary, reel game/feature can add the possibility of winning a relatively large payout. A bonus reel game/feature may require an additional wager, but typically does not. A single play of a reel game can constitute a single complete game or wager, e.g., a single spin of the reels or a series of spins which culminate in a final aggregate outcome. Depending on implementation, in addition to a base reel game, an electronic gaming device can conduct a bonus reel game and/or a gateway wheel game. A reel game uses spinning reels and one or more reel areas (game windows) on a display screen.

In examples described herein, the set of reels of an electronic gaming device include a mix of one or more skill-based reels and one or more RNG-event-based reels. The skill-based reel(s) and RNG-event-based reel(s) have associated reel strips. The reel strip for an RNG-event-based reel includes symbol instances. The reel strip for a skill-based reel also includes symbol instances, but the type of symbols depends in implementation. In some examples, the skill-based reel is a feature selection reel, and the symbol instances of the reel strip for the skill-based reel represent different features such as different special modes, multipliers, supplemental features, or other options. In other examples, the skill-based reel is a symbol instance selection reel, and the symbol instances of the reel strip for the skill-based reel are the same type of symbol instances as for an RNG-event-based reel.

For a reel game, a reel area encloses viewable portions of a set of reels associated with the reel area. For each of the reels, the viewable portion of the reel includes one or more positions for instances of symbols. Thus, the reel area is a matrix of instances of symbols on a display screen, and may be highlighted graphically to emphasize reels and symbol instances within the reel area. The number of reels and dimensions of the reel area depend on implementation. In some configurations, a reel area has m reels and can enclose different counts of symbol instances for different reels. For example, a reel area encloses 4 symbol instances for a first reel, 6 symbol instances for each of a second reel, third reel, and fourth reel, and 4 symbol instances for a fifth reel. Such a configuration can be described as a 4-6-6-6-4 configuration. In typical configurations, a reel area has an m×n configuration, with m reels and with n symbol instances visible per reel. For example, for a base reel game, a reel area can have a 5×3 configuration—five reels per window, with three symbol instances showing in the window for each of the reels. More generally, the reel area spans m reels in a first dimension and spans n symbol instances in a second dimension orthogonal to the first dimension, where the value of m can be 4, 5, 6, 7, 8, or some other number of reels, and the value of n can be 2, 3, 4, 5, 6, or some other number of symbol instances, which can be the same or different for different reels. Typically, the m reels are arranged horizontally in the reel area from left-to-right, with the m reels spinning vertically and the reel area showing symbol instances of each of the respective reels. Alternatively, the m reels are arranged vertically in the reel area from top-to-bottom, with the m reels spinning horizontally and the reel area showing symbol instances of each of the respective reels. Alternatively, a reel area can have another configuration.

For each of the reels, a reel strip includes x positions along a one-dimensional strip of symbol instances, where x depends on implementation. For example, x is 30, 80, 100, 200, or some other number of positions. The value of x can be the same or different for different reels (thus, different reels can have different numbers of positions). Each reel can have a data structure (e.g., array, linked list, table) that tracks the symbol instances at the respective positions of the reel strip for the reel. In some implementations, the configuration of the symbol instances at the positions of the reel strips for the reels of a reel game is fixed after the reel game boots, although limited reconfiguration operations may be permitted. In other implementations, the configuration of the symbol instances at the positions of the reel strips for the reels of a reel game can change dynamically after the reel game boots (e.g., depending on bet amount or some other factor). Different sets of reels can be used for a base reel game, special mode of a base reel game, and bonus reel game or other supplemental feature. For example, for a special mode of a base reel game, more “valuable” symbols, such as a wild symbol or scatter symbol, can be added to the reels of a base reel game or swapped in for other symbols on the reels.

The symbol set for reels has various types of symbols, including one or more target symbols and other symbols. The symbols can be static or animated. Depending on implementation, the symbol set for the reels includes one or more target symbol types, at least one jackpot symbol type, a wild symbol type, some number of picture symbol types, some number of minor/low symbol types, and a scatter symbol type (which triggers bonuses). Alternatively, the symbol set for the reels can include other and/or additional symbols. In general, for a given type of symbol, one or more instances of the symbol can appear in a reel strip, but games can have different constraints on symbol placement. Depending on context, the term “symbol” can indicate a symbol type or a symbol instance. In general, an instance of wild symbol can substitute for any other symbol (except, in most implementations, a scatter symbol or jackpot symbol) when determining win conditions along pay lines. In general, an instance of a scatter symbol can contribute to a win condition even if it is not on the same pay line as another scatter symbol. In some implementations, a win condition depends on a count of instances of a scatter symbol that occur anywhere within a reel area, regardless of where they land within the reel area. The symbol set can be the same or different between a base reel game and bonus reel game (or other supplemental feature). Some types of symbols are dimmed out (not active) at times (e.g., symbols other than target symbols are dimmed out during a feature). For a skill-based reel that is a feature selection reel, symbol instances can represent options for a supplemental feature, special mode, bet multipliers, or other feature that may be activated upon the occurrence of a trigger condition, or that may simply be awarded.

As in a reel game with physical reels, the reels of a reel game on a display screen “spin” graphically through a reel area on the display screen when a player actuates a “spin” or “play” button, which acts as a “handle pull” event. For RNG-event-based reels, a backend system randomly selects symbol positions of reel strips at which to stop the reel strips for the respective reels, and the respective reels stop at the selected symbol positions of the reel strips, with some number of symbol instances visible in the game window for each of the reels. For example, for a given RNG-event-based reel, the backend system generates a random number and determines a symbol position at which to stop the reel strip of the reel using the random number (e.g., with a lookup table). The backend system generates different random numbers for the respective RNG-event-based reels that are spun. In this way, the backend system can determine which symbol instances of the respective RNG-event-based reels are visible in the game window (reel area) on the display screen. In other scenarios, symbol instances visible in a reel area can be “transferred” from another reel area when certain conditions are satisfied. For example, symbol instances can be graphically transferred or otherwise added to the reel area for a bonus reel game from a base reel game upon the occurrence of certain conditions for the base reel game. For a skill-based reel, the symbol position of the reel strip at which to stop the skill-based reel depends on user input. For example, a user actuates a button (e.g., physical button, touchscreen button, or other virtual button) and, based on the timing the button actuation, the symbol position at which to stop the reel strip for the skill-based reel is determined.

In general, a display screen (or simply “display” or “screen”) for a reel game is an area that conveys information to a viewer. The information may be dynamic, in which case, the display screen may use LCD technology, LED technology, cathode ray tube (CRT) technology, or some other display technology. A main display screen (also called a primary game screen or main display) can be a display screen or an area of a display screen used to display game information related to a base reel game, such as a video representation of one or more spinning reels. A secondary display screen (also called a secondary game screen or bonus display) can be a display screen or an area of a display screen used to display secondary game information, such as animations and other graphics associated with a bonus reel game. A credit display can display a player's current number of credits, cash, account balance, or the equivalent. A bet display can display a player's amount wagered. The credit display and/or bet display may be standalone displays, independent of the main display and bonus display. Alternatively, the credit display and/or bet display can be incorporated into the main display or bonus display. Any of the display screens can be implemented as a touchscreen, with an associated touchscreen controller. In this case, such display screens may be operated as input devices in addition to presenting information, to provide input game play decisions (e.g., actions on and selection of game presentation objects).

An electronic gaming device may award a special mode for a base reel game, a bonus reel game, or a supplemental feature to a player. A special mode, bonus reel game, or supplemental feature may enhance the electronic gaming device and the experience of players by adding elements of excitement and chance. The special mode, bonus reel game, or supplemental feature can utilize a different set of reels, display screens, controls, symbols, etc. than the base reel game in normal operation. Alternatively, the special mode, bonus reel game, or supplemental feature can reuse or reconfigure at least some of the reels, display screens, symbols, etc. of a base reel game. The special mode, bonus reel game, or supplemental feature can be started in response to satisfaction of a trigger condition. For example, a special mode, bonus reel game, or supplemental feature can be triggered upon the occurrence of some defined combination of symbol instances or threshold count of target symbol instances in one or more sets of reels. Alternatively, the special mode, bonus reel game, or supplemental feature can be triggered in some other way (e.g., randomly).

In general, a backend system can determine various outcomes and perform operations for various types of base reel games, special modes, and supplemental features. A UI system can then output indications of those outcomes and perform operations for various types of base reel games, special modes, and supplemental features. For example, for various types of events, the backend system uses an RNG (which can be a cryptographic RNG or PRNG) to generate a random number and maps the random number to an outcome using a lookup table. This series of operations is generally referred to as an RNG event. FIG. 3 shows examples of lookup tables 322A-322N, which are also called weighted tables. In general, a lookup table can be implemented as any data structure that assigns probabilities to different options, in order for one of the different options to be selected using a random number. Different options are represented in different entries of a lookup table. The probabilities for different options can be reflected in threshold values (e.g., for a random number RND, generated by an RNG, in the range 0<RND<=100, with four options, 0<RND<=40 for option 1, 40<RND<=70 for option 2, 70<RND<=90 for option 3, and 90<RND<=100 for option 4). The threshold values can represent percentages or, more generally, sub-ranges within the range for a random number. In some implementations, the threshold values for a lookup table are represented as count values (weights) for the respective entries of the lookup table. For example, the following table shows count values for the four options described above:

TABLE 1
Example Lookup Table

| count value | entry |
|---|---|
| 40 | <value a1, value a2, . . . > |
| 30 | <value b1, value b2, . . . > |
| 20 | <value c1, value c2, . . . > |
| 10 | <value d1, value d2, . . . > |

The sum total of the count values (weights) indicates the range of the options. The backend system can use a random number, generated between 1 and the sum total of the count values, to select one of the entries in the lookup table by comparing the random number to successive running totals. In the example shown in Table 1, if the random number is 40 or less, the first entry is selected. Otherwise, if the random number is between 41 and 70, the second entry is selected. Otherwise, if the random number is between 71 and 90, the third entry is selected. Otherwise, the last entry is selected. The threshold values for a lookup table can be fixed and predetermined. Or, the threshold values for a lookup table can vary dynamically (e.g., depending on bet amount). Or, a lookup table can be dynamically selected (e.g., depending on bet amount, depending on another factor) from among multiple available lookup tables. Different parameters or choices during game play can use different lookup tables. Or, different combinations of parameters or choices can be combined in entries of a given lookup table.

In general, after RNG-event-based reels have landed (stopped) in a reel area, any win conditions can be detected and any win amounts can be awarded to the player (e.g., credited to the player's credit balance). In some examples, a skill-based reel is a symbol instance selection reel, and symbol instances of the skill-based reel contribute to win conditions. In other examples, a skill-based reel is a feature selection reel, and symbol instances of the skill-based reel do not directly contribute to win conditions (although they can affect award amounts, in some cases, e.g., as a multiplier). In still other implementations, the reel strip for a skill-based reel includes a mix of symbol instances that contribute to win conditions and symbol instances that do not directly contribute to win conditions.

In some examples, win conditions depend on a count of target symbol instances in a reel area. In other examples, win conditions are defined as combinations of symbol instances along pay lines (also called win lines) across at least a portion of a reel area on a display screen. Typically, a pay line is traversed from one side of the reel area to the opposite side of the reel area (e.g., left to right), using one symbol instance per reel along the pay line as part of possible combinations of symbol instances. For a round of play, when a certain combination of symbol instances appears along a pay line, a win amount corresponding to that combination of symbol instances and that pay line is awarded. Win amounts can vary according to the combination of symbol instances and according to the particular pay line along which the combination of symbol instances appears. Win amounts are typically determined according to a pay table, where the pay table comprehends the various combinations of symbol instances and pay lines that may occur (examples of win conditions). The win amount for a round of play may be a fraction of an amount wagered for that round of play for certain win conditions. For other win conditions, the win amount may be much larger than the amount wagered. The number of pay lines and base credit cost to play depends on implementation. There can be 2×, 3×, 4×, and 5× bet multipliers. Multipliers can also appear as symbols in reels, such as an RNG-event-based reel and/or a skill-based reel. Alternatively, there could be higher bet multipliers (e.g., up to 8×), different credit options, and/or a different number of pay lines.

Depending on implementation, symbol instances along a pay line can be counted in different ways. For example, when evaluating a win condition along a pay line, symbol instances along the pay line in any reel can be counted, even if the reels are not adjacent. Alternatively, when evaluating a win condition along a pay line, only symbol instances along the pay line in adjacent reels are counted. For a given pay line, only the highest-paying combination of symbol instances is awarded. Alternatively, for a given pay line, all possible combinations of symbol instances are awarded, in the aggregate. A given symbol instance (e.g., wild symbol) is counted only towards its highest-paying combination in a given pay line. Alternatively, a given symbol instance can be counted towards multiple combinations in a given pay line.

Instead of evaluating win conditions on explicitly designated pay lines across reels in a reel area, an award can be determined according to a “ways” approach, which is also referred to herein as “all-ways evaluation” or simply “ways evaluation.” For all-ways evaluation, each possible path through designated (active) symbol display position(s) of the respective reels provides a way to win. A path is traversed from one side of the reel area to the opposite side of the reel area (e.g., left to right), using one symbol instance per reel along the path. For one symbol instance per reel in a combination, any symbol instance displayed at an active symbol display position for a given reel in the reel area can be used to form a symbol instance combination with any symbol instance displayed at an active display position of each of the other reels. As a result, the total number of ways to win is determined by multiplying the number of active display position(s) of each reel. For example, for five reels each showing three symbol instances at active display positions in a reel area, there are 3⁵=243 ways to win for all-ways evaluation. As another example, for five reels each showing four symbol instances at active display positions in a reel area, there are 4⁵=1024 ways to win for all-ways evaluation. As another example, for five reels, with the first and last reels each showing four symbol instances and the other reels each showing six symbol instances at active display positions in the reel area, there are 4×6×6×6×4=3456 ways to win for all-ways evaluation. As a final example, for five reels, with the first and last reels each showing four symbol instances and the other reels each showing ten symbol instances at active display positions in the reel area, there are 4×10×10×10×4=16000 ways to win for all-ways evaluation.

For all-ways evaluation, the designated (active) symbol display positions for the respective reels can be pre-defined and static. For example, the designated (active) symbol display positions for each reel can be all of the symbol display positions enclosed in a reel area for the reel. Or, the designated (active) symbol display positions for the respective reels can change, e.g., depending on a bet amount. In some implementations, an individual reel can be selected to have all symbol display positions active or only a single symbol display position active, e.g., for different bet amounts. That is, the symbol instance displayed in any symbol display position can be used for a selected reel. For example, depending on the bet amount, all symbol display positions per reel can be active for one reel, two reels, three reels, four reels, or five reels. If all symbol display positions are not active for a reel, then only one symbol display position is active for that reel for all-ways evaluation. For example, for five reels each showing three symbol instances in a reel area, if three reels are selected, there are 3×3×3×1×1=27 ways to win for all-ways evaluation. For such all-ways evaluation, each possible path through the designated (active) symbol display position(s) of the respective reels provides a way to win. The total number of ways to win is determined by multiplying the number of active symbol display position(s) of each reel, where the active symbol display position(s) for a reel are all symbol display positions in the reel area for a selected reel but only the designated (e.g., center) symbol display position in the reel area for a non-selected reel.

In some implementations, for all-ways evaluation using a set of reels, a backend system determines which symbol display positions of the reel area are active for the reels, respectively. For example, the backend system determines which symbol display positions of the reel area are active for the reels, respectively, depending on the bet amount. Alternatively, the symbol display positions of the reel area that are active for the reels, respectively, can be pre-defined and static. In any case, for all of the possible paths through the active symbol display positions of the reel area, the backend system evaluates combinations of instances of symbols along the possible paths for one or more win conditions. Each of the possible paths uses one of the instances of symbols per reel and crosses the reel area from one side of the reel area to an opposite side of the reel area (e.g., left to right).

### IV. EXAMPLE IMPLEMENTATIONS IN AN ELECTRONIC GAMING DEVICE

This section describes example implementations in an electronic gaming device, in which the innovations described herein can be implemented. The example implementations are presented to provide examples of context for the innovations. The innovations described herein can be used in other implementations. For example, the innovations described herein can be used in implementations of an electronic gaming device with different hardware features and/or different gameplay mechanics. Also, although the innovations described herein can be used in combination, the innovations described herein can also be used separately.

In the example implementations, a reel area of a display screen of an electronic gaming device has five reels. For a base reel game, the reel area encloses three symbol display positions per reel. Alternatively, a different reel configuration can be used.

In some of the example implementations, the set of reels includes a single skill-based reel and four RNG-event-based reels. The single skill-based reel is a feature selection reel. Alternatively, the set of reels can include multiple skill-based reels that are feature selection reels, or one or more skill-based reels that are symbol instance selection reels, or multiple skill-based reels that include a mix of feature selection reel(s) and symbol instance selection reel(s). For the RNG-event-based reels and any of the skill-based reels that are symbol instance selection reels, the symbol types include a highest-value symbol, a high-value symbol, various lower-value symbol types of different denominations, a wild symbol, and a scatter symbol. The scatter symbol can be a dynamic symbol that is resolved to one of several different scatter symbol types upon a spin. Alternatively, other and/or additional symbol types can be used.

In the example implementations, a player can choose a bet denomination (e.g., one cent, two cents, five cents) or use a default bet denomination for a base reel game. The player can also choose a bet amount (e.g., different amounts of credits) or use a default bet amount. The bet amount affects the number of reels that are selected for all-ways evaluation—from one reel up to five reels, depending on the bet amount. The player can also choose a bet multiplier (e.g., 1×, 2×, 3×, 4×, 5×) or use a default bet multiplier (e.g., 1×). Alternatively, other bet settings, evaluation approaches, etc. can be used.

The player initiates a spin for the base reel game (e.g., pushing a spin button). The spin uses the bet denomination, bet amount, and bet multiplier in effect (either default or selected by the player), assuming credits are sufficient in a credit meter. The credit meter decreases by the bet size. Various aspects of gameplay can depend on the bet denomination, bet amount, and bet multiplier in effect, as described below.

For each of the one or more skill-based reels, the player provides user input to stop the reel. For each of the RNG-event-based reels, the reel stops depending on a RNG event. Various examples of the timing of operations to determine stop positions are described below.

In some implementations, a reel area includes one or more skill-based reels and one or more RNG-event-based reels. Alternatively, a reel area includes the RNG-event-based reels but the skill-based reel(s) are in a separate display area. Or, as another alternative, a reel area includes the RNG-event-based reels but a skill-based reel is implemented using a wheel, either in a separate display area or as a separate physical mechanism.

For the spin of the base reel game, an outcome is determined. For example, a determination is made whether a trigger condition is satisfied for a selected feature of a feature selection reel. Also, win conditions are evaluated. The example implementations can use all-ways evaluation, with the number of selected (active) reels depending on bet amount. The number of active reels can be one reel (the first reel), two reels (the first two reels), three reels (the first three reels), four reels (the first four reels), or five reels (all reels). Win conditions are evaluated on possible paths starting from one side of the reel area and continuing (one symbol instance per reel) to the opposite side of the reel area (e.g., left to right). For any given symbol instance, only the highest-value combination is awarded. Win conditions count symbol instances on adjacent reels along a path, except for scatter symbol instances.

Alternatively, outcomes can be evaluated using a different approach in the base reel game. For example, outcomes are evaluated using a conventional approach with one or more pay lines. In any case, after the outcome evaluation for a spin of the base reel game, any credits from winning combinations of symbol instances are shown in a win meter and added to a credit meter.

When a supplemental feature, special mode, or free games feature for the base reel game is triggered, the spin of the base reel game proceeds in the supplemental feature, special mode, or free games feature for the base reel game. Various aspects of the base reel game can be adjusted. After outcome evaluation, any credits from winning combinations of symbol instances are shown in a win meter and added to a credit meter.

### V. USING A SET OF REELS WITH ONE OR MORE SKILL-BASED REEL AND ONE OR MORE RNG-EVENT-BASED REELS

This section describes innovations for a gameplay mechanic used to control the user interface (“UI”) of an electronic gaming device. The gameplay mechanic uses one or more skill-based reels in conjunction with one or more RNG-event-based reels. The skill-based reel(s) and RNG-event-based reel(s) spin when an instance of a base reel game or other process starts. A player uses a button press or provides other user input to determine a stop position on a reel strip for a spinning skill-based reel, which stops at the determined stop position. If timed skillfully, the player can select a desired game feature or desired symbol instances for the skill-based reel. The RNG-event-based reel(s) stop at positions determined using one or more RNGs. The selected game feature or symbol instances from the skill-based reel(s) are then evaluated in conjunction with symbol instances that land for the RNG-event-based reels. The gameplay mechanic increases user engagement and interaction with the electronic gaming device. In particular, by providing a way to select a desired game feature or desired symbol instances, the gameplay mechanic provides the player some control over an outcome. The innovations described herein also provide ways to satisfy gaming regulations and RTP requirements while using a mix of skill-based reel(s) and RNG-event-based reel(s) in an electronic gaming device.

### A. EXAMPLES OF SKILL-BASED REELS FOR FEATURE SELECTION

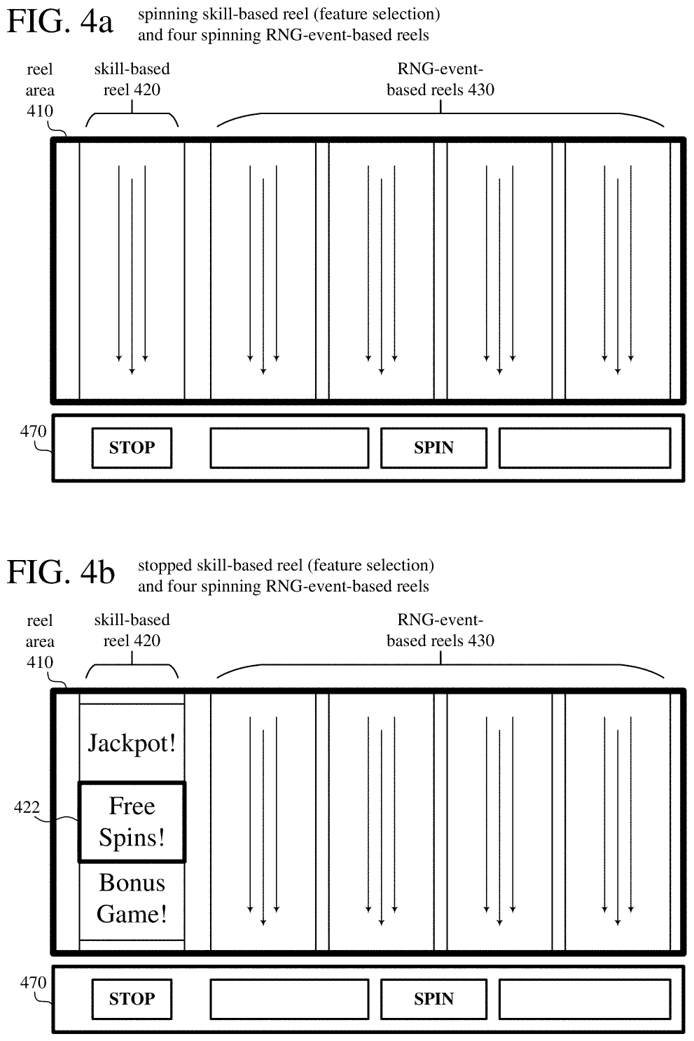

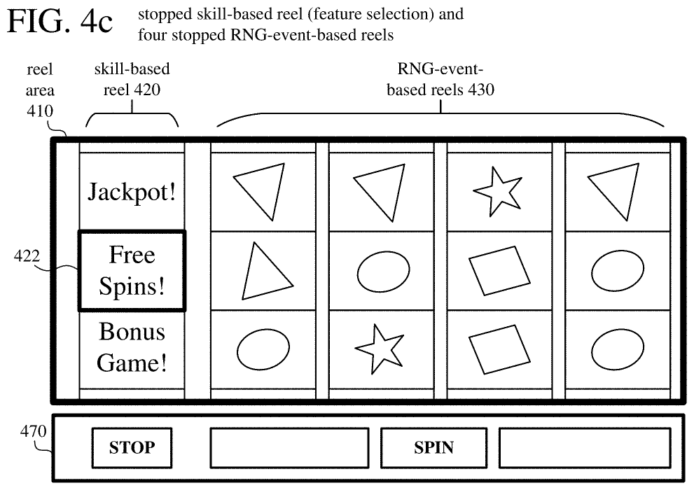

FIGS. 4a-4c show a user interface (“UI”) of an electronic gaming device that uses a set of reels, including a skill-based feature selection reel and four RNG-event-based reels, for a process (e.g., base reel game). In the UI, the reel area 410 includes a skill-based reel 420 and four RNG-event-based reels 430. The skill-based reel 420 is the leftmost reel in the reel area 410. Other options for configurations of reels in a reel area are described below.

In the example of FIGS. 4a-4c, the available stop positions of the reel strip of the skill-based reel 420 indicate options for game features. The stop positions of the reel strip of the skill-based reel 420, which is a feature selection reel in FIGS. 4a-4c, do not include symbol instances that count towards winning combinations in an instance (e.g., spin, play) of the process. The skill-based reel 420 has “pachislo” functionality—a player selects the stop position of the skill-based reel 420, which provides the player the ability to “time” the stop position and thereby select a desired game feature. This introduces an element of skill to the stopping of the skill-based reel 420. In contrast, the stop positions of the RNG-event-based reels 430 are determined based on randomly generated events (e.g., random numbers from one or more RNGs.) The stop positions of the reel strips of the RNG-event-based reels 430 include symbol instances that count towards winning combinations in the instance of the process.

The UI also includes a supplemental display area 470, which includes controls such as a “stop” button that the player can actuate to stop the spinning of the skill-based reel 420 and a “spin” button the player can actuate to start an instance of the process, spinning all of the reels. The supplemental display area 470 can also present information such as a bet amount, bet denomination, available credits, and/or a win amount. The supplemental display area 470, or another display area, can also present information that indicates which of the reels 420, 430 is skill-based and which of the reels 420, 430 is RNG-event-based, and the effects of the respective reels 420, 430.

In FIG. 4a, the skill-based reel 420 and four RNG-event-based reels 430 are spinning in the reel area 410. In FIG. 4b, the skill-based reel 420 has stopped in response to user input (here, actuation of the “stop” button), but the four RNG-event-based reels 430 are still spinning in the reel area 410. The selected stop position 422 is associated with the selected game feature. In FIG. 4b, the selected feature is a “free spins” feature, which triggers (or potentially triggers, if a condition is satisfied) one or more additional spins of the reels of the process. Other game features—such as a “jackpot” feature and “bonus game” feature—in the reel area 410 for the skill-based reel 420 are not selected.

In FIG. 4c, the four RNG-event-based reels 430 have also stopped in the reel area 410. Symbol instances on the reel strips for the respective RNG-event-based reels 430 have landed in the reel area 410. The outcome of the base reel game is determined using the symbol instances for the respective RNG-event-based reels 430 that have landed in the reel area 410.

In some implementations, the selected game feature is triggered (e.g., activated, started, or awarded, depending on the feature) regardless of which symbol instances have landed for the respective RNG-event-based reels 430. In such implementations, the skill-based reel 420 gives a player control over what game feature the player gets.

In other implementations, the selected game feature is conditionally triggered depending on which symbol instances have landed for the respective RNG-event-based reels 430 (which depends on the stop positions determined for the reel strips of the respective RNG-event-based reels 430). For example, the trigger condition is occurrence of a combination of symbol instances such as three-of-a-kind or four-of-a-kind, among the symbol instances that have landed for the respective RNG-event-based reels 430, along a payline through the reel area 410. Or, as another example, the trigger condition is occurrence of a threshold count of scatter symbols in the reel area 410, among the symbol instances that have landed for the respective RNG-event-based reels 430. In such implementations, the skill-based reel 420 still gives a player control over what game feature the player might get (that is, will get if the trigger condition is satisfied).

The options for the game features depend on implementation. In some cases, a game feature provides a “gateway” to another mode, without regard to a result of one or more RNG-event-based reels. In other cases, a game feature provides a modifier to a result of one or more RNG-event-based reels. For example, when the instance of the process is a spin of a base reel game, the conditionally triggered, selected game feature can be:
a selection of cash-on-reels (or hold-and-spin) feature, bonus mode, or other special mode or game feature, which can be started from the base reel game, depending on results of the RNG-event-based reels in the base reel game;
a re-trigger feature to restart a special mode or game feature, or to add some number of instances (spins, plays, etc.) or free games to the special mode or game feature;
a selection of a number of free spins that can be awarded in the base reel game, depending on results of the RNG-event-based reels in the base reel game;
a selection of a multiplier for the base reel game, which can be awarded in the base reel game, depending on results of the RNG-event-based reels in the base reel game;
a jackpot, which can be awarded in the base reel game, depending on results of the RNG-event-based reels in the base reel game; or
credits, which can be won depending on results of the RNG-event-based reels.

In other cases, the selected game feature is triggered without regard to whether a condition is satisfied. For example, when the instance of the process is a spin of a base reel game, the selected game feature can be any of the game features listed in the preceding paragraph, regardless of the results of the RNG-event-based reels in the base reel game.

In some cases, the selected game feature does not affect the base amount awarded in the instance of the process, which depends on the results of the RNG-event-based reels. In other cases, the selected game feature affects the base amount awarded in the instance of the process (e.g., as a bet multiplier).

If the options of a feature selection reel are balanced with regard to RTP, the stop positions for RNG-event-based reels can be determined before (or after) the stop positions for the skill-based reels, without adjustments to the RNG-event-based reels. On the other hand, if the options of a feature selection reel are not balanced with regard to RTP, adjustments can be made to reel strips for RNG-event-based reels and/or how stop positions are determined for the reel strips for RNG-event-based reels, to balance overall RTP, as described below.

The options of a feature selection reel can change depending on bet amount, bet denomination, loyalty reward status, or some other factor. Or, as another alternative, the options of a feature selection reel can change depending on whether a placement cost (to add an option to the feature selection reel) has been paid by the user. The placement cost for an option can be an amount of credits, a monetary value, or another amount. Thus, the options of the feature selection reel can be adjusted (e.g., by dynamic symbol resolution) depending on bet amount, bet denomination, or whether a placement cost has been paid, so as to balance overall RTP.

### B. Examples of Skill-Based Reels for Symbol Instance Selection

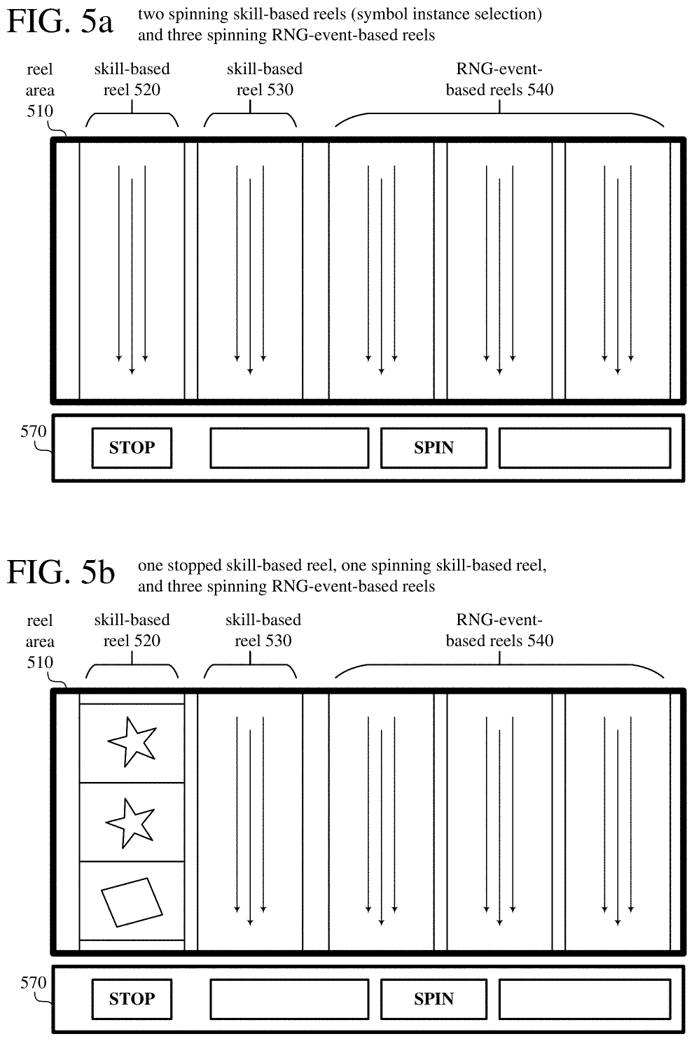

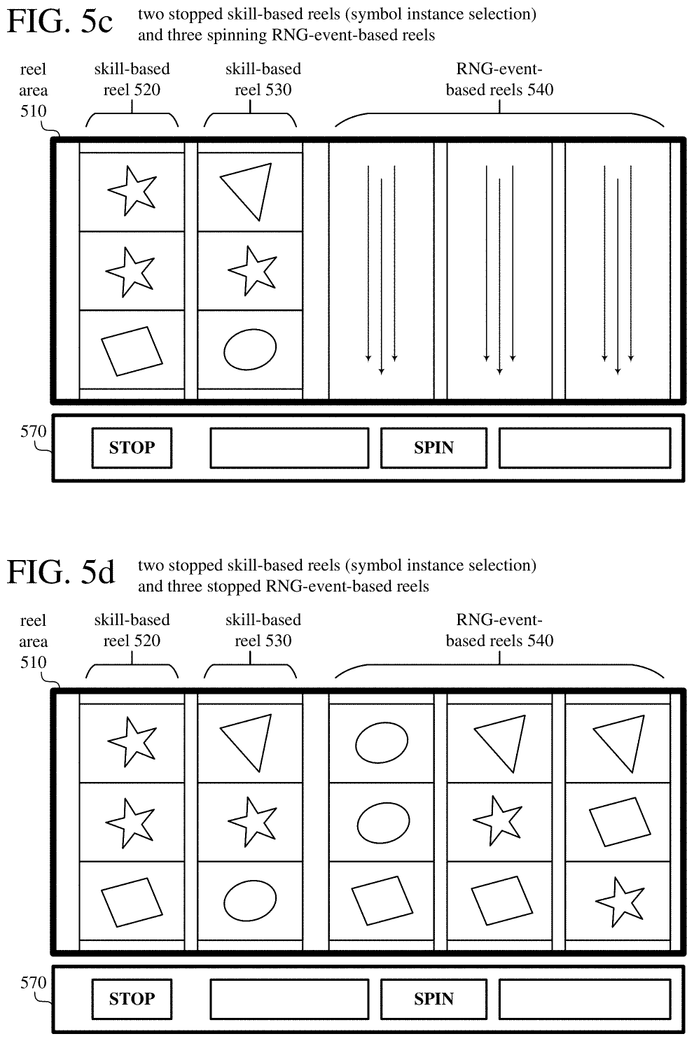

FIGS. 5a-5d show a UI of an electronic gaming device that uses a set of reels, including two skill-based reels (for symbol instance selection) and three RNG-event-based reels, for a process (e.g., base reel game). In the UI, the reel area 510 includes two skill-based reels 520, 530 and three RNG-event-based reels 540. The skill-based reels 520, 530 are the leftmost reels in the reel area 510. Other options for configurations of reels in a reel area are described below.

In the example of FIGS. 5a-5d, the available stop positions of the reel strip of the skill-based reels 520, 530 indicate options for symbol instances. That is, the stop positions of the reel strips of the skill-based reels 520, 530 include symbol instances that count towards winning combinations in an instance (e.g., spin, play) of the process. For the skill-based reels 520, 530 (individually or together), a player selects the stop positions of the skill-based reels 520, 530, which provides the player the ability to “time” the stop positions and thereby select desired symbol instances. This introduces an element of skill to the stopping of the skill-based reels 520, 530. The stop positions of the reel strips of the RNG-event-based reels 540 also include symbol instances that count towards winning combinations in the instance of the process. The stop positions of the RNG-event-based reels 540, however, are determined based on randomly generated events (e.g., random numbers from one or more RNGs.)

The UI also includes a supplemental display area 570, which includes controls such as a “stop” button that the player can actuate to stop the spinning of the skill-based reels 520, 530 and a “spin” button the player can actuate to start an instance of the process, spinning all of the reels. The supplemental display area 570 can also present information such as a bet amount, bet denomination, available credits, and/or a win amount. The supplemental display area 570, or another display area, can also present information that indicates which of the reels 520, 530, 540 is skill-based and which of the reels 520, 530, 540 is RNG-event-based, and the effects of the respective reels 520, 530, 540.

In FIG. 5a, the two skill-based reels 520, 530 and three RNG-event-based reels 540 are spinning in the reel area 510. In FIG. 5b, one of the skill-based reels 520 has stopped in response to user input (here, actuation of the “stop” button), but the remaining skill-based reel 530 and the three RNG-event-based reels 540 are still spinning in the reel area 510. In FIG. 5b, the reel area 510 includes symbol instances of the reel strip of the stopped skill-based reel 520. In FIG. 5c, the other skill-based reel 530 has stopped in response to user input (here, actuation of the “stop” button), but the three RNG-event-based reels 540 are still spinning in the reel area 510. In FIG. 5c, the reel area 510 includes symbol instances of the reel strips of both stopped skill-based reels 520, 530.

In FIG. 5d, the three RNG-event-based reels 540 have also stopped in the reel area 510. Symbol instances on the reel strips of the respective RNG-event-based reels 540 have landed in the reel area 510. The outcome of the base reel game is determined using the symbol instances for the skill-based reels 520, 530 and the symbol instances for the respective RNG-event-based reels 540 that have landed in the reel area 510.

The symbol instances for a skill-based reel can include a mix of symbol instances of different types comparable to the mix of symbol instances for an RNG-event-based reel. For example, the symbol instances for a skill-based reel and the symbol instances for an RNG-event-based reel can include comparable proportions of “normal” symbols and “special” symbols (such as scatter symbols, wild symbols, high-value symbols). A wild symbol, in general, can be substituted for another type of symbol (except, typically, a scatter symbol) in a winning combination. For a scatter symbol, the winning combination is a threshold count of instances of the scatter symbol that occur anywhere within a reel area. Like an RNG-event-based reel, the reel strip for a skill-based reel can include positions for dynamically assigned symbols. Or, the reel strip for a skill-based reel can include positions for statically assigned symbols, while the reel strip for an RNG-event-based reel includes positions for dynamically assigned symbols.

The symbol instances of a skill-based reel can change depending on bet amount, bet denomination, loyalty reward status, or some other factor. Or, as another alternative, the symbol instances of a skill-based reel can change depending on whether a placement cost (to add a symbol instance to the skill-based reel) has been paid by the user. The placement cost for a symbol instance can be an amount of credits, a monetary value, or another amount. Thus, the symbol instances of the skill-based reel can be adjusted (e.g., by dynamic symbol resolution) depending on bet amount, bet denomination, or whether a placement cost has been paid, so as to balance overall RTP.

In other examples, for a cash-on-reels feature or hold-and-spin feature, the symbol instances for a skill-based reel can include instances of credit symbols that represent credit values. Upon satisfaction of a condition (e.g., at least a threshold count of credit symbol instances landing for the skill-based reel(s) and the RNG-event-based reel(s) in the reel area), the credit values of the credit symbol instances landing in the reel area are awarded. Thus, the stop positions of the reel strip of a skill-based reel can include credit symbol instances that count towards winning combinations in an instance of the process, in that the credit symbol instances are counted in determining whether the condition is satisfied. A player selects the stop positions of the skill-based reel, which provides the player the ability to “time” the stop positions and thereby select credit symbol instances. This introduces an element of skill to the stopping of a skill-based reel for the cash-on-reels or hold-and-spin feature. The stop positions of the reel strips of the RNG-event-based reel(s) also include credit symbol instances that count towards winning combinations in the instance of the process.

### C. Example Configuration Options for Skill-Based Reels and RNG-Event-Based Reels

The skill-based reel(s) and RNG-event-based reel(s) of an electronic gaming device can be configured in various ways, depending on implementation. The skill-based reel(s) and RNG-event-based reel(s) are typically implemented as video reels, but can alternatively be implemented as physical stepper reels. Or, a skill-based reel can be implemented as a physical wheel separate from the reel area that includes the RNG-event-based reel(s).

1. Count, Locations, and Attributes of Reels in Reel Area.

Depending on implementation, the count of skill-based reel(s), count of RNG-event-based reels, arrangement of reels, and other attributes of the reels can change. In some implementations, attributes of the reels can dynamically change depending on various factors.

In general, the electronic gaming device has at least one RNG-event-based reel, so as to comply with architectural constraints. Otherwise, the count of skill-based reel(s) and count of RNG-event-based reels can vary depending on implementation.

The count of skill-based reel(s) and count of RNG-event-based reels can be static or dynamic. In some implementations, an electronic gaming device includes a single skill-based reel and multiple RNG-event-based reels. Alternatively, an electronic gaming device includes multiple skill-based reels and multiple RNG-event-based reels. In general, if the skill-based reel(s) are symbol instance selection reels, the count of skill-based reels is in a range from one reel up to the total count of reels minus 1 (that is, there is at least one RNG-event-based reel). If the skill-based reel(s) are feature selection reels, and a selected feature is automatically triggered, the count of skill-based reels is in a range from one reel up to the total count of reels minus 1 (that is, there is at least one RNG-event-based reel). On the other hand, if the skill-based reels are feature selection reels, and a selected feature is conditionally triggered, the count of skill-based reels is in a range from one reel up to the total count of reels minus n, where n represents a number of reels needed to form a combination of symbol instances for a trigger condition (or win condition, more generally). For example, if an electronic gaming device has five reels and three symbol instances in a pay line are needed to win, the electronic gaming device can have two skill-based feature selection reels. As another example, if an electronic gaming device has five reels and four symbol instances in a pay line are needed to win, the electronic gaming device can have only one skill-based feature selection reel.

The skill-based reel(s) can be used for all instances of a process. Alternatively, the skill-based reel(s) can be enabled or disabled depending on bet amount, bet denomination, loyalty reward status, or some other factor, or the skill-based reel(s) can be enabled or disabled depending on a random event or result of a previous instance of a process (e.g., big win). As another alternative, the skill-based reel(s) can be enabled or disabled depending on user selection to enable or disable the skill-based reel(s). As another alternative, the skill-based reel(s) can be enabled or disabled depending on whether a placement cost has been paid by the user.

The arrangement of skill-based reel(s) and RNG-event-based reels can be static or dynamic. In some implementations, an electronic gaming device includes a single skill-based reel and one or more RNG-event-based reels. Typically, the single skill-based reel is the leftmost reel in a reel area. In some implementations, the reels stop in a left-to-right manner, with the skill-based reel stopping prior to the RNG-event-based reels, which simplifies implementation in some architectures. Alternatively, the skill-based reel is in another location in a reel area (e.g., rightmost reel, center reel, other reel location). Or, the location of the skill-based reel can be dynamically assigned for an instance of a process, potentially being arranged in any reel location in a reel area. Similarly, if an electronic gaming device includes multiple skill-based reels and one or more RNG-event-based reels, the locations of the skill-based reels can be static (e.g., leftmost reels, rightmost reels, reels on opposite sides) or dynamically assigned.

The game features or symbol instances (evaluated for win conditions) associated with stop positions of a reel strip of a skill-based reel depend on implementation. Examples of game features (not evaluated for win conditions) and symbol instances (evaluated for win conditions) are described above. The reel strip for a skill-based reel can include game features, symbol instances, or a mix of game features and symbol instances.

Aside from count and location of skill-based reels, various other attributes of the skill-based reel(s) depend on implementation. For example, such other attributes include how fast the skill-based reel(s) spin, direction of spin of the skill-based reel(s), sizes of “hit boxes” for stop positions on the skill-based reel(s), and whether a “nudge” effect is enabled. A skill-based reel can have equal-sized hit boxes for stop positions on the reel strips of the skill-based reel. Or, a skill-based reel can have different-sized hit boxes (some larger or smaller than others) for different stop positions, making it easier or harder for the player to select a given stop position. The “nudge” effect permits a player to “nudge” a skill-based reel (or even an RNG-event-based reel) up or down to a more valuable stop position.

The various attributes can change depending on bet amount, bet denomination, loyalty reward status, payment of a placement cost by the user, or some other factor, or the attribute(s) can change depending on a random event or result of a previous instance of a process (e.g., big win). For example, the attribute(s) can change if the factor is above a threshold amount, or the attribute(s) can vary in a more fine-grained way depending on the factor. In general, an adjustable attribute has a more valuable option for some values of a factor (e.g., higher bet amount, higher bet denomination), and a less valuable option for other values of the factor (e.g., lower bet amount, lower bet denomination). For example, the adjustable attribute(s) can include: (a) how fast the skill-based reel(s) spin, with the skill-based reel(s) spinning faster for some values of the factor and spinning slower for other values of the factor; (b) size of “hit boxes” for the respective stop positions of a reel strip of a skill-based reel, with larger “hit boxes” for stop positions associated with valuable game features or symbol instances for some values of the factor; (c) the count of skill-based reel(s), with fewer skill-based reel(s) being used for some values of the factor and more skill-based reel(s) being used for other values of the factor; (d) which symbol instances are in the skill-based reel(s), with less valuable symbol instances being used for some values of the factor and more valuable symbol instances being used for other values of the factor; (e) which game features are in the skill-based reel(s), with less valuable game features being used for some values of the factor and more valuable game features being used for other values of the factor; (f) direction of spin of the skill-based reel(s); (g) enabling or disabling an effect to permit a player to nudge a skill-based reel (or even an RNG-event-based reel) up or down to a more valuable stop position; and (h) whether a given reel is a skill-based reel or an RNG-event-based reel, if the reel can switch between being a skill-based reel or being an RNG-event-based reel.

Stop positions and associated game features of a skill-based reel can be made inactive after they have been selected, until stop positions and associated game features of the skill-based reel are reset. For example, a skill-based reel can be used to implement a “task completion” mechanism. In this case, the options for the skill-based reel are associated with different tasks. As soon as a task is completed (“beat”), that task is dimmed out in the skill-based reel and can no longer be selected. When all tasks are completed (“beat”), a game feature can be triggered. Or, as another example, a skill-based reel can be used to implement a “knock out” mechanism. In this case, the player eliminates options for the skill-based reel to eliminate options (dim out or remove) that a player does not want, until a final option remains for selection. Or, as another option, a skill-based reel can be used to implement a “replacement” mechanism, with which a player can replace the option at a selected stop position with some other option.

In general, the timing of (a) determination of stop position(s) for the reel strip(s) of the skill-based reel(s) versus (b) generation of random number(s) and determination of stop position(s) for the reel strip(s) of the RNG-event-based reel(s) can vary depending on implementation. In particular, such timing can depend on whether options associated with the possible stop positions for the reel strip(s) of the skill-based reel(s) are already balanced with regard to RTP. The next two sections describe different approaches for such timing.

2. Timing of Operations for Skill-Based Reel Options that are Balanced with Regard to RTP.

In some architectures, the options associated with different stop positions for a skill-based reel are supposed to be at least roughly equivalent in terms of RTP. Any given option is not supposed to be better than the others. For example, each option/stop position for a skill-based reel should have the same RTP.

Suppose the stop positions for the reel strip of a skill-based reel are balanced with respect to RTP, such that they do not affect overall RTP for a base reel game in different ways (e.g., they provide game features or symbol instances of approximately equal value, or different placement costs to place the options at different stop positions effectively balance the options with respect to RTP, or different activation costs to use the options at different stop positions effectively balance the options with respect to RTP). In this case, the timing of operations is more flexible to (a) determine the stop position for the reel strip of the skill-based reel, and (b) generate random numbers and determine stop positions for the reel strips of the RNG-event-based reels. At some point after user input indicates a start to the instance of the process, the backend system can determine the stop positions for the reel strips of the RNG-event-based reels. At the frontend, all of the reels can spin, and the stop position for the reel strip of the skill-based reel is determined, before or after the determination of the stop positions for the reel strips of the RNG-event-based reels. The frontend system sends a notification (to the backend system) that indicates the stop position for the reel strip of the skill-based reel. The backend system receives the notification and evaluates results in view of the stop position for the reel strip of the skill-based reel and the stop positions for the reel strips of the RNG-event-based reels.

In a typical architecture, an RNG engine determines stop positions for all spinning reels, which are RNG-event-based reels. The processing pipeline for such an architecture can be modified to (1) allow for the stop position for a skill-based reel to be determined outside the RNG engine, and potentially to be different for different instances of a process, (2) receive a notification indicating the stop position for the skill-based reel, and (3) determine the outcome based on the result for the skill-based reel and results for the RNG-event-based reels. Typically, a backend system is local to an electronic gaming device or connected by a fast network connection to the electronic gaming device, such that delay is not problematic.

Thus, if the options associated with stop positions for a skill-based reel are balanced with respect to RTP, RNG events for RNG-event-based reels can happen after the selection of the stop position for the skill-based reel. For example, user input is received that causes all of the reels to spin (e.g., a “spin” button is actuated). In response, the skill-based reel(s) and RNG-event-based reel(s) spin. For each of the skill-based reel(s), the player selects a stop position on the reel strip for the skill-based reel, and the skill-based reel stops. Subsequently, the backend system executes RNG calls and determines stop position(s) for the RNG-event-based reel(s). The RNG-event-based reel(s) also stop, at the stop position(s) determined for them. The backend system determines an outcome using the results of the skill-based reel(s) and RNG-event-based reel(s), and an indication of the outcome is displayed.

Or, RNG events for RNG-event-based reels can instead happen before the selection of the stop position for a skill-based reel, if the options associated with stop positions for the skill-based reel are balanced with respect to RTP. Such an approach can work, for example, for an electronic gaming device with physical reels. For example, user input is received that causes all of the reels to spin (e.g., a “spin” button is actuated). In response, the skill-based reel(s) and RNG-event-based reel(s) spin. The backend system immediately executes RNG calls in response to the user input and determines stop position(s) for the RNG-event-based reel(s). After that, for each of the skill-based reel(s), the player selects a stop position on the reel strip for the skill-based reel, and the skill-based reel stops. The RNG-event-based reel(s) also stop, at the stop position(s) determined for them. The backend system determines an outcome using the results of the skill-based reel(s) and RNG-event-based reel(s), and an indication of the outcome is displayed.

3. Timing of Operations for Skill-Based Reel Options that are Not Balanced with Regard to RTP.

An architecture can permit options associated with different stop positions for a skill-based reel to be non-balanced in terms of RTP. A given option can be better than the others. For example, at least one option/stop position for a skill-based reel can have a significantly different RTP than the others (e.g., 2× multiplier versus 5× multiplier, or 5 free spins versus 20 free spins, or a wild symbol instance versus a normal symbol instance).

Suppose the possible stop positions for the reel strip of a skill-based reel are not balanced with respect to RTP, such that they affect overall RTP for a base reel game in different ways (e.g., providing different numbers of free spins, providing different bet multipliers, or providing a full character symbol, a dynamic symbol, wild symbol, or normal symbol that counts toward a win condition). In this case, at the backend system, the stop position for the reel strip of the skill-based reel can be determined first (e.g., by the frontend system receiving user input to stop the skill-based reel, stopping the skill-based reel, and sending a notification to the backend system that indicates the stop position for the reel strip of the skill-based reel). Before the stop positions for the reel strips of the RNG-event-based reels are determined at the backend system, the RNG-event-based reels can be adjusted to balance overall RTP. For example, the backend system gets the notification that indicates the stop position for the reel strip of the skill-based reel, adjusts the reel strip(s), lookup table(s), dynamically assigned symbol instances, etc. for one or more of the RNG-event-based reels to compensate, and then determines the stop positions for the reel strips of the RNG-event-based reels. Or, after the stop position for the skill-based reel has been selected, an activation cost to use the option at the stop position of the skill-based reel can be adjusted to balance overall RTP. The activation cost for an option can be an amount of credits, a monetary value, or another amount. For example, the backend system gets the notification that indicates the stop position for the reel strip of the skill-based reel, then adjusts the activation cost for the option at the stop position to compensate.

More generally, to balance RTP between options for different stop positions of a skill-based reel, an electronic gaming device can perform various adjustments. For example, the electronic gaming device can swap reel strips of one or more RNG-event-based reels depending on the selected stop position of the skill-based reel. Or, the electronic gaming device can change how dynamic symbols are resolved depending on the selected stop position of the skill-based reel. (This could be implemented by changing the lookup table used for symbol instance selection or otherwise changing how dynamic symbol resolution happens.) Or, the electronic gaming device can swap symbol instances in reel strips depending on the selected stop position of the skill-based reel. Or, the electronic gaming device can assign a different activation cost to the option associated with the selected stop position of the skill-based reel. Or, the electronic gaming device can balance overall RTP in some other way. Applicable rules about showing changes to a player can be followed, or they can limit which adjustments are made.

In a typical architecture, an RNG engine determines stop positions for all spinning reels, which are RNG-event-based reels. The processing pipeline for such an architecture can be modified to (1) allow for the stop position for a skill-based reel to be determined outside the RNG engine, and potentially to be different for different instances of a process, (2) receive a notification indicating the stop position for the skill-based reel, (3) react to the notification to balance overall RTP (e.g., by adjusting reel strips, lookup tables, dynamic symbol resolution, etc. for the RNG-event-based reels, or by assigning an activation cost to the stop position for the skill-based reel), and (4) determine the outcome based on the result for the skill-based reel and results for the RNG-event-based reels. Typically, a backend system is local to an electronic gaming device or connected by a fast network connection to the frontend system for the electronic gaming device, such that delay is not problematic. Adjustments for the RNG-event-based reels can happen while the RNG-event-based reels are spinning, without introducing delay that is perceptible to the player.

Thus, if the options associated with stop positions for a skill-based reel are not balanced with respect to RTP, RNG events for RNG-event-based reels can happen after the selection of the stop position for the skill-based reel. For example, user input is received that causes all of the reels to spin (e.g., a “spin” button is actuated). In response, the skill-based reel(s) and RNG-event-based reel(s) spin. For each of the skill-based reel(s), the player selects a stop position on the reel strip for the skill-based reel, and the skill-based reel stops. Subsequently, based on the selected stop position(s) for the skill-based reel(s), the backend system adjusts reel strips, lookup tables, dynamic symbol resolution, and/or other features of the RNG-event-based reel(s), or assigns new activation cost(s) to the selected stop position(s) for the skill-based reel(s). Then, the backend system executes RNG calls and determines stop position(s) for the RNG-event-based reel(s). At the electronic gaming device, the RNG-event-based reel(s) stop, at the stop position(s) determined for them. The backend system determines an outcome using the results of the skill-based reel(s) and RNG-event-based reel(s), and an indication of the outcome is displayed.

It is also possible, if the options associated with stop positions for a skill-based reel are not balanced with respect to RTP, for RNG events for RNG-event-based reels to happen before the selection of the stop position for a skill-based reel. For example, user input is received that causes all of the reels to spin (e.g., a “spin” button is actuated). In response, the skill-based reel(s) and RNG-event-based reel(s) spin. The backend system executes RNG calls for the RNG-event-based reel(s). Then, for each of the skill-based reel(s), the player selects a stop position on the reel strip for the skill-based reel, and the skill-based reel stops. Subsequently, based on the selected stop position(s) for the skill-based reel(s), the backend system adjusts reel strips, lookup tables, dynamic symbol resolution, and/or other features of the RNG-event-based reel(s), or assigns new activation cost(s) to the selected stop position(s) for the skill-based reel(s). Then, the backend system determines stop position(s) for the RNG-event-based reel(s). At the electronic gaming device, the RNG-event-based reel(s) stop, at the stop position(s) determined for them. The backend system determines an outcome using the results of the skill-based reel(s) and RNG-event-based reel(s), and an indication of the outcome is displayed.

Or, as another example, user input is received that causes all of the reels to spin (e.g., a “spin” button is actuated). In response, the skill-based reel(s) and RNG-event-based reel(s) spin. The backend system executes RNG calls for the RNG-event-based reel(s) and determines stop position(s) for the RNG-event-based reel(s). Then, for each of the skill-based reel(s), the player selects a stop position on the reel strip for the skill-based reel, and the skill-based reel stops. Subsequently, based on the selected stop position(s) for the skill-based reel(s), the backend system adjusts reel strips, dynamic symbol resolution, and/or other features of the RNG-event-based reel(s), e.g., to change the proportion of valuable symbol instances), even though the stop position(s) of the RNG-event-based reels have been determined. At the electronic gaming device, the RNG-event-based reel(s) stop, at the stop position(s) determined for them. The backend system determines an outcome using the results of the skill-based reel(s) and RNG-event-based reel(s), and an indication of the outcome is displayed.

### D. Example Techniques for Controlling the UI of an Electronic Gaming Device with Skill-Based Reel(s) and RNG-Event-Based Reel(s)

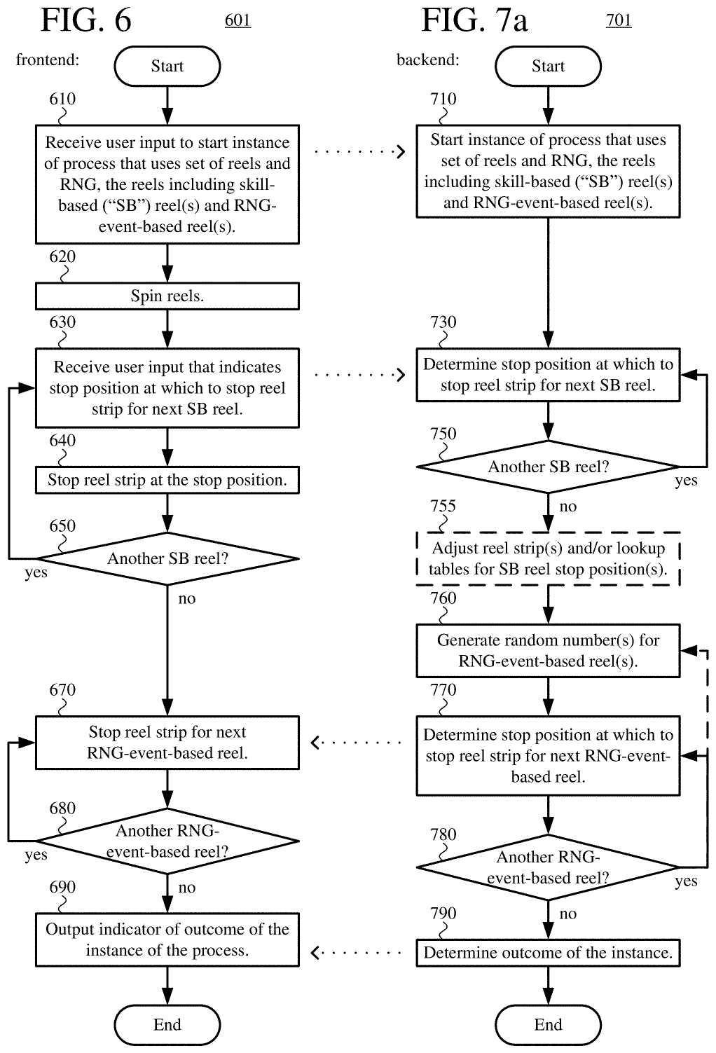

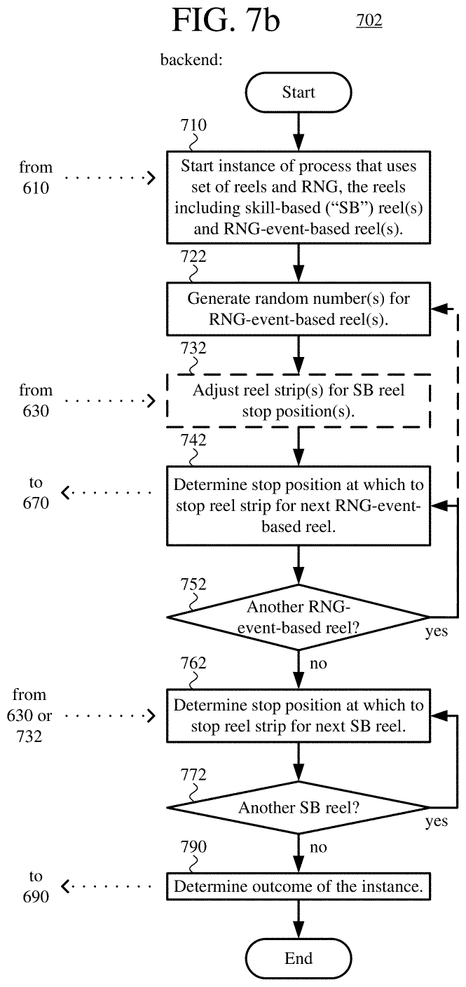

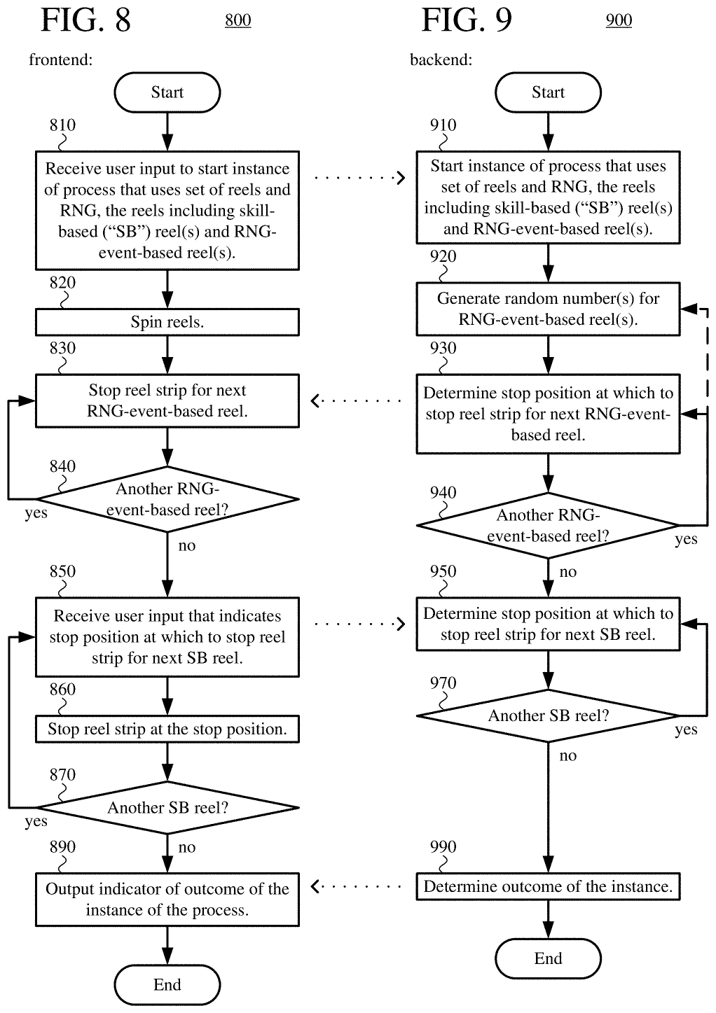

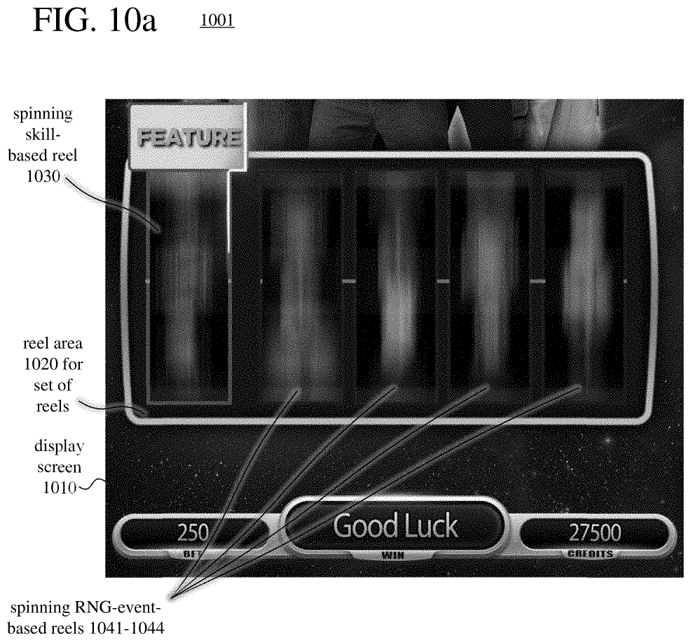

FIGS. 6 and 7a show example techniques 601, 701 for controlling the UI of an electronic gaming device such as an electronic gaming machine (“EGM”), which has a set of reels including one or more skill-based reels and one or more RNG-event-based reels. The example technique 601 of FIG. 6 focuses on UI frontend activity, whereas the example technique 701 of FIG. 7a focuses on backend activity. FIG. 7b shows an alternative example technique 702, focusing on backend operations with different timing of operations. FIGS. 8 and 9 show alternative example techniques 800, 900 for controlling the UI of an electronic gaming device with a set of reels including one or more skill-based reels and one or more RNG-event-based reels. The example technique 800 of FIG. 8 focuses on frontend activity, whereas the example technique 900 of FIG. 9 focuses on backend activity.

Thus, FIGS. 6 and 8 show operations from the perspective of a UI frontend. Operations of the example technique 601 shown in FIG. 6 or example technique 800 shown in FIG. 8 can be performed, for example, in a UI system 302 explained with reference to FIG. 3. In contrast, FIGS. 7a, 7b, and 9 show operations from the perspective of a backend. Operations of the example technique 701, 702, and 900 shown in FIGS. 7a, 7b, and 9, respectively, can be performed, for example, in a game processing backend system 314 explained with reference to FIG. 3.

The game processing backend system and UI system can be implemented using memory and one or more processors that are part of the electronic gaming device and/or part of a gaming system located remotely from the electronic gaming device. Depending on implementation, the backend system and UI system can be implemented by software executable on a CPU, by software controlling special-purpose hardware (e.g., a GPU or other graphics hardware for video acceleration), and/or by special-purpose hardware (e.g., in an ASIC), to process game play instructions in accordance with game play rules, determine outcomes in accordance with game play rules, and/or generate outputs (e.g., to one or more display screens and/or speakers).

In general, the example techniques 600, 701, 702, 800, 900 shown in FIGS. 6, 7a, 7b, 8, and 9 use one or more reel areas on one or more display screens of an electronic gaming device. The reel area(s) can be displayed on a single display screen (e.g., main display screen, or secondary display screen). Or, the reel areas(s) can be split among multiple display screens (e.g., one reel area on a first display screen, and a reel area on a second display screen). The number of reel areas depends on implementation. As used herein, the term “game window” or “reel area” can be used interchangeably.

In the techniques 600, 701, 702, 800, 900 shown in FIGS. 6, 7a, 7b, 8, and 9, respectively, a process uses a set of reels. Each of the reels has a reel strip, which for UI-focused operations can be displayed as spinning through a reel area on a display screen of the electronic gaming device upon a spin of the reel. In some implementations, the process is a base reel game. Alternatively, the process can be a feature or other type of process. The set of reels includes m reels, where m depends on implementation. For example, m is 3, 4, or 5. In particular, the set of reels includes one or more skill-based reels and one or more RNG-event-based reels. Section V.D.6 describes some example configurations for the skill-based reel(s) and RNG-event-based reel(s) in the example techniques 601, 701, 702, 800, and 900. Section V.D.7 describes some of the possible kinds of skill-based reel(s) that can be used in the example techniques 601, 701, 702, 800, and 900.

1. Example UI Frontend Operations with Skill-Based Reel(s) Stopping First.

With reference to FIG. 6, at stage 610, a UI system (such as the UI system 302 described with reference to FIG. 3) receives user input at the electronic gaming device. The user input indicates a start to an instance of a process that uses a set of reels and at least one RNG. The UI system sends a notification to the backend system of the user input, or otherwise notifies the backend system that the instance of the process should be started (as shown by the dotted line from stage 610). At stage 620, the UI system spins the set of reels.

For each of the skill-based reel(s), the UI system receives (stage 630) user input that indicates a stop position at which to stop a reel strip for the skill-based reel and (stage 640) stops the reel strip for the skill-based reel at the stop position for the skill-based reel. For example, the user input that indicates the stop position at which to stop the reel strip for the skill-based reel is a button press of a physical button, touchscreen button, or other virtual button, or other user input. The UI system sends a notification to the backend system of the user input, or otherwise notifies the backend system of the stop position at which to stop the reel strip for the skill-based reel, as shown by the dotted line from stage 630.

The UI system checks (stage 650) whether there are any more skill-based reels to stop and, if so, continues at stage 630. Notifications to the backend system indicating the stop positions for multiple skill-based reels can be batched and sent together. In any case, in the example technique 601 of FIG. 6, the stopping of the reel strip(s) for the skill-based reel(s) precedes the stopping of the reel strip(s) for the RNG-event-based reel(s).

After the skill-based reel(s) have stopped, for each of the one or more RNG-event-based reels, the UI system stops (stage 670) the reel strip for the RNG-event-based reel at a stop position that has been determined based at least in part on a random number generated by the RNG. The UI system checks (stage 680) whether there are any more RNG-event-based reels to stop and, if so, continues at stage 670. As shown by the dotted line to stage 670, the UI system receives one or more notifications from the backend system that indicate the determined stop position(s) for the reel strip(s) of the RNG-event-based reel(s). In some implementations, the UI system can receive such notification(s) earlier, e.g., before spinning the reels at stage 620, if options for the possible stop positions of the reel strip(s) of the skill-based reel(s) are balanced with respect to RTP.

At stage 690, the UI system outputs an indicator of an outcome of the instance of the process. As shown by the dotted line to stage 690, the UI system receives a notification from the backend system that specifies the outcome. The outcome is based at least in part on instances of symbols in a reel area for the stopped RNG-event-based reel(s). For example, the indicator of the outcome of the instance of the process is a graphical indicator for an event associated with the stop position of the reel strip for one of the skill-based reel(s), such as an animation or other graphical depiction for the event, accompanied by audio output. Or, as another example, if the trigger condition is not satisfied for the event associated with the stop position of the reel strip for the skill-based reel, the indicator of the outcome can so indicate, e.g., with a default indicator of an outcome for instances of the process. Or, as another example, the indicator of the outcome of the instance of the process is an animation or other graphical indicator for a win amount, accompanied by audio output.

In some implementations, the UI system can adjust how the skill-based reel(s) are graphically depicted. For example, the UI system can adjust the rate of spin for at least one of the skill-based reel(s). Or, as another example, the UI system can adjust the direction of spin for at least one of the skill-based reel(s). Or, as another example, the UI system can adjust instances of symbols on the reel strip for at least one of the skill-based reel(s). Or, as another example, the UI system can adjust sizes of hit boxes for options on the reel strip for at least one of the skill-based reel(s). Or, as another example, the UI system can adjust whether a “nudge” effect is enabled or disabled for at least one of the one or more skill-based reels. The UI system can adjust any, or all, of these things depending on bet amount, denomination, loyalty reward status, payment of a placement cost, payment of an activation cost, a result of a previous instance of the process, or another factor.

If the skill-based reel(s) are used iteratively for a gaming session, when a game feature associated with the stop position of the reel strip is selected, the stop position, or the game feature, can be indicated to be inactive in one or more subsequent instances of the process. For example, the stop position or game feature can be “dimmed out” for the one or more subsequent instances of the process, until all stop positions/game features are reset. Alternatively, stop positions/game features remain active across all of the iterations.

2. Example Backend Operations if Skill-Based Reel(s) Stop First.

With reference to FIG. 7a, at stage 710, a backend system (such as the game processing backend system 314 described with reference to FIG. 3) starts an instance of a process that uses a set of reels and at least one RNG. The backend system receives a notification (with an indicator based on user input) from the UI frontend system, indicating that the instance of the process should be started, as shown by the dotted line to stage 710.

For each of the skill-based reel(s), the backend system receives a notification (with an indicator based on user input) from the UI system, indicating a stop position at which to stop the reel strip for the skill-based reel, as shown by the dotted line to stage 730. Notifications to the backend system indicating the stop positions for multiple skill-based reels can be batched and received together.

For each of the skill-based reel(s), the backend system determines (stage 730) a stop position at which to stop a reel strip for the skill-based reel. As explained, the stop position at which to stop the reel strip for the skill-based reel is based on user input, which the UI frontend has received. The backend system checks (stage 750) whether there are any more skill-based reels to stop and, if so, continues at stage 730.

In the example technique 701 shown in FIG. 7a, the stop position(s) of the reel strip(s) of the skill-based reel(s) are determined (based on one or more notifications from the UI system, which are based on user input) before the generation of random number(s) for the RNG-event-based reel(s). In some implementations, for each of the skill-based reel(s), different stop positions of the reel strip for the skill-based reel are balanced with respect to RTP. In other implementations, for at least one of the skill-based reel(s), or between multiple skill-based reels, different stop positions of the reel strip(s) for the skill-based reel(s) are not balanced with respect to RTP. In this case, the backend system can compensate by making adjustments to the RNG-event-based reel(s). FIG. 7a shows such adjustments as optional stage 755. At stage 755, for at least one of the RNG-event-based reel(s), the backend system adjusts (a) the reel strip for the RNG-event-based reel, (b) a lookup table associated with the RNG-event-based reel, (c) how dynamic symbols are resolved for the reel strip for the RNG-event-based reel, and/or (d) some other attribute of the RNG-event-based reel. In this way, the backend system can balance overall RTP for the instance of the process in view of the varying RTP associated with determined stop position(s) of the reel strip(s) for the skill-based reel(s). Alternatively, the backend system can assign new activation cost(s) for different stop position(s) of the reel strip(s) for the skill-based reel(s), so as to balance overall RTP for the instance of the process in view of the varying RTP associated with determined stop position(s) of the reel strip(s) for the skill-based reel(s).

After stop positions for the skill-based reel(s) have been determined, for each of the one or more RNG-event-based reels, the backend system generates (stage 760) a random number using the RNG and determines (stage 770), based at least in part on the random number, a stop position at which to stop a reel strip for the RNG-event-based reel. For example, the backend system performs a lookup operation for the random number in a lookup table, which includes entries that indicate different stop positions of the reel strip for the RNG-event-based reel, thereby determining one of the different stop positions at which to stop the reel strip for the RNG-event-based reel. As indicated in FIG. 7a, the random numbers for multiple RNG-event-based reels can be determined before corresponding lookup operations for those RNG-event-based reels, or a random number can be generated and used to determine a stop position for one RNG-event-based reel at a time.

The backend system checks (stage 780) whether there are any more RNG-event-based reels to stop and, if so, continues at stage 770. As shown by the dotted line from stage 770, the backend system sends one or more notifications to the UI system that indicate the determined stop position(s) for the RNG-event-based reel(s).

At stage 790, the backend system determines an outcome of the instance of the process. The outcome is based at least in part on instances of symbols in a reel area for the stopped RNG-event-based reel(s). (At this point, the instances of the symbols might not be stopped in the reel area by the UI system, but the backend system nevertheless considers them to be in the reel area.) As shown by the dotted line from stage 790, the backend system sends a notification to the UI system that specifies the outcome. The outcome of the instance of the process can include an event associated with the stop position of the reel strip for one of the skill-based reel(s). In this case, the outcome of the instance of the process can depend on satisfaction of a trigger condition. For example, the trigger condition is a count of special symbols (such as scatter symbols) among the instances of symbols in the reel area for the stopped reels or a combination of symbols among the instances of symbols in the reel area for the stopped reels. If the trigger condition is not satisfied, the notification can so indicate, e.g., with a default indicator of an outcome for instances of the process. Alternatively, the outcome of the instance of the process can include a win amount, which is based upon any instances of symbols in the reel area for the stopped reels.

In some implementations, the backend system can control one or more attributes of the skill-based reel(s). For example, the backend system can adjust the rate of spin for at least one of the skill-based reel(s). Or, as another example, the backend system can adjust the direction of spin for at least one of the skill-based reel(s). Or, as another example, the backend system can adjust the count of the skill-based reel(s). Or, as another example, the backend system can adjust instances of symbols on the reel strip for at least one of the skill-based reel(s). Or, as another example, the backend system can adjust sizes of hit boxes for options on the reel strip for at least one of the skill-based reel(s). Or, as another example, the backend system can adjust whether a “nudge” effect is enabled or disabled for at least one of the one or more skill-based reels. Or, as another example, the backend system can adjust whether a given reel of the set of reels is used as one of the skill-based reel(s) or used as one of the RNG-event-based reel(s). The backend system can adjust any, or all, of these things depending on bet amount, denomination, loyalty reward status, payment of a placement cost, payment of an activation cost, a result of a previous instance of the process, or another factor.

If the skill-based reel(s) are used iteratively for a gaming session, when a stop position or game feature associated with the stop position of the reel strip is selected, the stop position or game feature can be made inactive in one or more subsequent instances of the process. For example, the stop position or game feature can be rendered non-selectable for the one or more subsequent instances of the process, until the stop positions/game features are reset. Alternatively, stop positions/game features remain active across all of the iterations.

3. Alternative Backend Operations if Skill-Based Reel(s) Stop First.

FIG. 7b shows operations of a backend system according to a different approach, in which the stop position(s) of the reel strip(s) of the skill-based reel(s) are determined (based on one or more notifications from the UI system, which are based on user input) after the generation of random number(s) for the RNG-event-based reel(s).

With reference to FIG. 7b, at stage 710, a backend system (such as the game processing backend system 314 described with reference to FIG. 3) starts an instance of a process that uses a set of reels and at least one RNG, as described with reference to FIG. 7a.

For each of the one or more RNG-event-based reels, the backend system generates (stage 722) a random number using the RNG. The random numbers for multiple RNG-event-based reels can be determined together, or a random number can be generated for one reel at a time.

For each of the skill-based reel(s), the backend system receives a notification from the UI system of an indicator (based on user input) of a stop position at which to stop the reel strip for the skill-based reel, as shown by the dotted line to stage 732. Notifications to the backend system indicating the stop positions for multiple skill-based reels can be batched and sent together. In the example technique 702 shown in FIG. 7b, the determination of stop position(s) of the reel strip(s) of the skill-based reel(s) (based on the notification(s), which are based on user input) follows the generation of random number(s) for the RNG-event-based reel(s). In some implementations, for each of the skill-based reel(s), different stop positions of the reel strip for the skill-based reel are balanced with respect to RTP. In other implementations, however, for at least one of the skill-based reel(s), or between multiple skill-based reels, different stop positions of the reel strip(s) for the skill-based reel(s) are not balanced with respect to RTP. In this case, the backend system can compensate by making adjustments to the RNG-event-based reel(s). FIG. 7b shows such adjustments as optional stage 732. At stage 732, for at least one of the one or more RNG-event-based reels, the backend system adjusts the reel strip of the RNG-event-based reel to balance RTP in view of the determined stop position(s) for the skill-based reel(s) (e.g., the backend system adjusts instances of symbols of the reel strip). In this way, the backend system can balance RTP in view of the determined stop position(s) of the reel strip(s) for the skill-based reel(s). Alternatively, the backend system can assign new activation cost(s) for different stop position(s) of the reel strip(s) for the skill-based reel(s), so as to balance RTP in view of the determined stop position(s) of the reel strip(s) for the skill-based reel(s).

For each of the one or more RNG-event-based reels, the backend system determines (stage 742), based at least in part on a random number from stage 722, a stop position at which to stop a reel strip for the RNG-event-based reel. For example, the backend system performs a lookup operation as described with reference to FIG. 7a. The backend system checks (stage 752) whether there are any more RNG-event-based reels to stop and, if so, continues at stage 742. As shown by the dotted line from stage 742, the backend system sends one or more notifications to the UI system that indicate the determined stop position(s) for the RNG-event-based reel(s).

For each of the skill-based reel(s), the backend system determines (stage 762) a stop position at which to stop a reel strip for the skill-based reel. As explained, the stop position at which to stop the reel strip for the skill-based reel is based on user input. The backend system checks (stage 772) whether there are any more skill-based reels to stop and, if so, continues at stage 762.

At stage 790, the backend system determines an outcome of the instance of the process, as described with reference to FIG. 7a. In some implementations, the backend system can control one or more attributes of the skill-based reel(s), as described with reference to FIG. 7a. Also, if the skill-based reel(s) are used iteratively for a gaming session, when a game feature associated with the stop position of the reel strip is selected, the game feature can be made inactive in one or more subsequent instances of the process, as described with reference to FIG. 7a.

4. Example UI System Operations with RNG-Event-Based Reel(s) Stopping First.

With reference to FIG. 8, at stage 810, a UI system (such as the UI system 302 described with reference to FIG. 3) receives user input at the electronic gaming device, as described with reference to FIG. 6. The UI system sends a notification to the backend system of the user input, or otherwise notifies the backend system that the instance of the process should be started, as shown by the dotted line from stage 810. At stage 820, the UI system spins the set of reels.

In contrast to the example technique 601 of FIG. 6, in the example technique 800 of FIG. 8, RNG-event-based reel(s) stop before skill-based reel(s) in the reel area. This presumes that the options for the stop positions of the reel strip(s) of the skill-based reel(s) are balanced with respect to RTP (or, with assigned activation costs, will be balanced with respect to RTP).

For each of the one or more RNG-event-based reels, the UI system stops (stage 830) the reel strip for the RNG-event-based reel at a stop position that has been determined based at least in part on a random number generated by the RNG. The UI system checks (stage 840) whether there are any more RNG-event-based reels to stop and, if so, continues at stage 830. As shown by the dotted line to stage 830, the UI system receives one or more notifications from the backend system that indicate the determined stop position(s) for the reel strip(s) of the RNG-event-based reel(s). In some implementations, the UI system can receive such notification(s) earlier, e.g., before spinning the reels at stage 820.

As noted above, for the example technique 800 shown in FIG. 8, the stopping of the reel strip for each of the skill-based reel(s) follows the stopping the reel strip for each of the RNG-event-based reel(s). For each of the skill-based reel(s), the UI system receives (stage 850) user input that indicates a stop position at which to stop a reel strip for the skill-based reel and (stage 860) stops the reel strip for the skill-based reel at the stop position for the skill-based reel. For example, the user input that indicates the stop position at which to stop the reel strip for the skill-based reel is a button press of a physical button, touchscreen button, or other virtual button, or other user input. The UI system sends a notification to the backend system of the user input, or otherwise notifies the backend system of the stop position at which to stop the reel strip for the skill-based reel, as shown by the dotted line from stage 850. The UI system checks (stage 870) whether there are any more skill-based reels to stop and, if so, continues at stage 850. Notifications to the backend system indicating the stop positions for multiple skill-based reels can be batched and sent together.

At stage 890, the UI system outputs an indicator of an outcome of the instance of the process, as described with reference to FIG. 6. As shown by the dotted line to stage 890, the UI system receives a notification from the backend system that specifies the outcome. In some implementations, the UI system can adjust how the skill-based reel(s) are graphically depicted, as described with reference to FIG. 6. Also, if the skill-based reel(s) are used iteratively for a gaming session, when a game feature associated with the stop position of the reel strip is selected, the stop position, or the game feature, can be indicated to be inactive in one or more subsequent instances of the process, as described with reference to FIG. 6.

5. Example Backend Operations if RNG-Event-Based Reel(s) Stop First.

With reference to FIG. 9, at stage 910, a backend system (such as the game processing backend system 314 described with reference to FIG. 3) starts an instance of a process that uses a set of reels and at least one RNG, as described with reference to FIG. 7a.

For each of the one or more RNG-event-based reels, the backend system generates (stage 920) a random number using the RNG. The random numbers for multiple RNG-event-based reels can be determined together, or a random number can be generated for one reel at a time.

For each of the one or more RNG-event-based reels, the backend system determines (stage 930), based at least in part on a random number from stage 920, a stop position at which to stop a reel strip for the RNG-event-based reel. For example, the backend system performs a lookup operation as described with reference to FIG. 7a. The random numbers for multiple RNG-event-based reels can be determined before corresponding lookup operations for those reels, or a random number can be generated and used to determine a stop position for one reel at a time. The backend system checks (stage 940) whether there are any more RNG-event-based reels to stop and, if so, continues at stage 920. As shown by the dotted line from stage 930, the backend system sends one or more notifications to the UI system that indicate the determined stop position(s) for the RNG-event-based reel(s).

In contrast to the example technique 701 of FIG. 7a, in the example technique 900 of FIG. 9, the stop position(s) of reel strip(s) of the RNG-event-based reel(s) are determined before the stop position(s) of the reel strip(s) of the skill-based reel(s). This presumes that the options for the possible stop positions of the reel strip(s) of the skill-based reel(s) are balanced with respect to RTP (or, with assigned activation costs, will be balanced with respect to RTP).

For each of the skill-based reel(s), the backend system receives a notification from the UI system of an indicator (based on user input) of a stop position at which to stop the reel strip for the skill-based reel, as shown by the dotted line to stage 950. Notifications to the backend system indicating the stop positions for multiple skill-based reels can be batched and sent together.

For each of the skill-based reel(s), the backend system determines (stage 950) a stop position at which to stop a reel strip for the skill-based reel. The backend system checks (stage 970) whether there are any more skill-based reels to stop and, if so, continues at stage 950.

At stage 990, the backend system determines an outcome of the instance of the process, as described with reference to FIG. 7a. In some implementations, the backend system can control one or more attributes of the skill-based reel(s), as described with reference to FIG. 7a. Also, if the skill-based reel(s) are used iteratively for a gaming session, when a game feature associated with the stop position of the reel strip is selected, the game feature can be made inactive in one or more subsequent instances of the process, as described with reference to FIG. 7a.

6. Example Configurations of Reels in the Example Techniques.

In some implementations, the reels of the set of reels are video reels on a display of the electronic gaming device. Alternatively, one or more of the reels of the set of reels is a physical reel of an electronic gaming device.

The number of skill-based reel(s) depends on implementation. For example, the set of reels includes a single skill-based reel. Or, as another example, the set of reels includes multiple skill-based reels. Typically, however, the set of reels includes at least one RNG-event-based reel.

The positioning of skill-based reel(s) also depends on implementation. For example, the skill-based reel(s) are positioned starting at one side of the reel area and continue across the reel area. The RNG-event-based reel(s) are positioned following the skill-based reel(s) across the reel area. Or, as another example, the skill-based reel(s) include multiple skill-based reels, which are positioned at different sides of the reel area. In this case, the RNG-event-based reel(s) are positioned between the multiple skill-based reels. Or, as another example, each of the skill-based reel(s) is positioned at a random location in the reel area for the instance of the process.

7. Example Skill-Based Reels in the Example Techniques.

The stop positions of the reel strip for a skill-based reel can indicate different options, depending on implementation.

At least one of the skill-based reel(s) can be a feature selection reel. In this case, the outcome of the instance of the process can be whether or not a game feature is activated, where the game feature is associated with the stop position of the reel strip for a given one of the skill-based reel(s). For example, the stop position is associated with a game feature centered within the reel area for a given one of the skill-based reel(s).

At least one of the skill-based reel(s) can be a symbol instance selection reel. In this case, the outcome of the instance of the process depends on win conditions for a combination of instances of symbols along possible paths through active symbol display positions of the reel area, with the possible paths crossing the skill-based reel(s). For each of the possible paths through the active symbol display positions of the reel area, the possible path uses one of the instances of symbols per reel and crosses the reel area from one side of the reel area to an opposite side of the reel area.

In a first variation, for one of the skill-based reel(s), different stop positions on the reel strip for the skill-based reel indicate options for types of supplemental feature. In this case, the stop position for a given one of the skill-based reel(s) indicates one of the types of supplemental feature. The supplemental feature can be triggered depending on a combination of instances of symbols among the instances of symbols in the reel area for the stopped RNG-event-based reel(s).

In a second variation, for one of the skill-based reel(s), different stop positions on the reel strip for the skill-based reel indicate options for types of special mode. In this case, the stop position for a given one of the skill-based reel(s) indicates one of the types of special mode. The special mode can be triggered depending on a combination of instances of symbols among the instances of symbols in the reel area for the stopped RNG-event-based reel(s).

In a third variation, for one of the skill-based reel(s), different stop positions on the reel strip for the skill-based reel indicate options for available reel strips for at least one of the RNG-event-based reel(s). In this case, the stop position for a given one of the skill-based reel(s) indicates one of the available reel strips to use as the reel strip for at least one of the RNG-event-based reel(s).

In a fourth variation, for one of the skill-based reel(s), different stop positions on the reel strip for the skill-based reel indicate options for types of conversions to apply to the reel strip for at least one of the RNG-event-based reels. In this case, the stop position for a given one of the skill-based reel(s) indicates one of the types of conversions to apply to the reel strip for at least one of the RNG-event-based reel(s).

In a fifth variation, for one of the skill-based reel(s), different stop positions on the reel strip for the skill-based reel indicate options for instances of symbols. In this case, the outcome can be further based at least in part on instances of symbols in the reel area for the stopped skill-based reel(s). For a cash-on-reels or hold-and-spin feature, the different stop positions on the reel strip for a skill-based reel can indicate options for instances of credit symbols that represent credit values.

In other variations, for one of the skill-based reel(s), different stop positions on the reel strip for the skill-based reel indicate one or more options for a trigger condition for the feature, a number of free games or free spins, a re-trigger feature to restart a special mode or game feature, a multiplier, or an award of credits.

The different variations can be used in combination. Thus, for example, different stop positions on the reel strip for a skill-based reel can indicate options drawn from different ones of the preceding variations.

In general, for any of the variations, for one of the skill-based reel(s), different positions on the reel strip for the skill-based reel can indicate options that depend on one or more of bet amount, denomination, payment of a placement cost, user selection, and loyalty reward status. Also, in general, for any of the variations, for one of the skill-based reel(s), different positions on the reel strip for the skill-based reel can indicate options that depend on a result of a previous instance of the process.

### E. Example Implementation

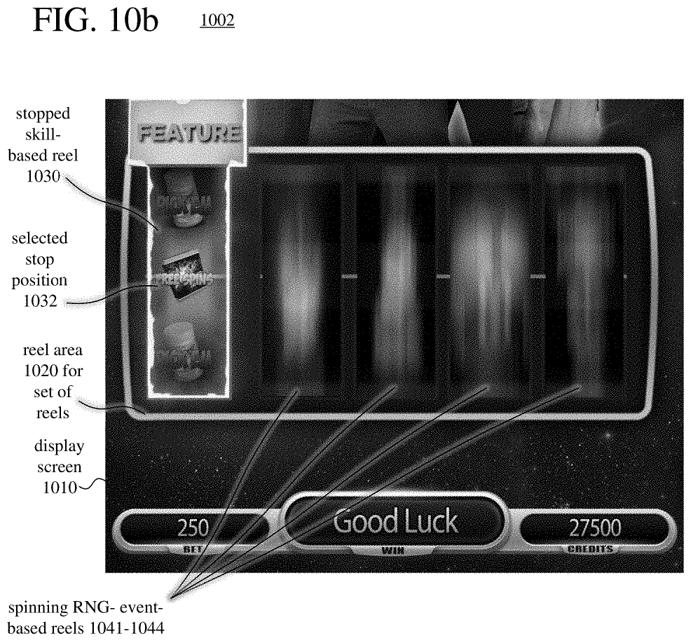

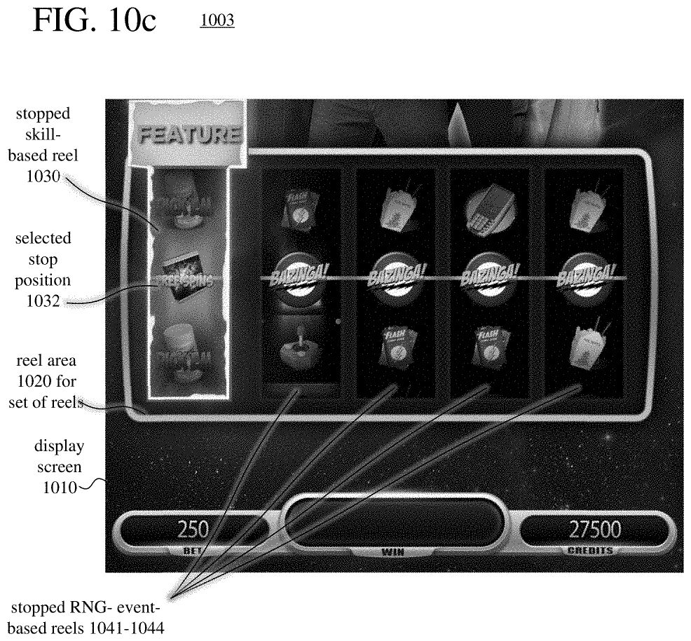

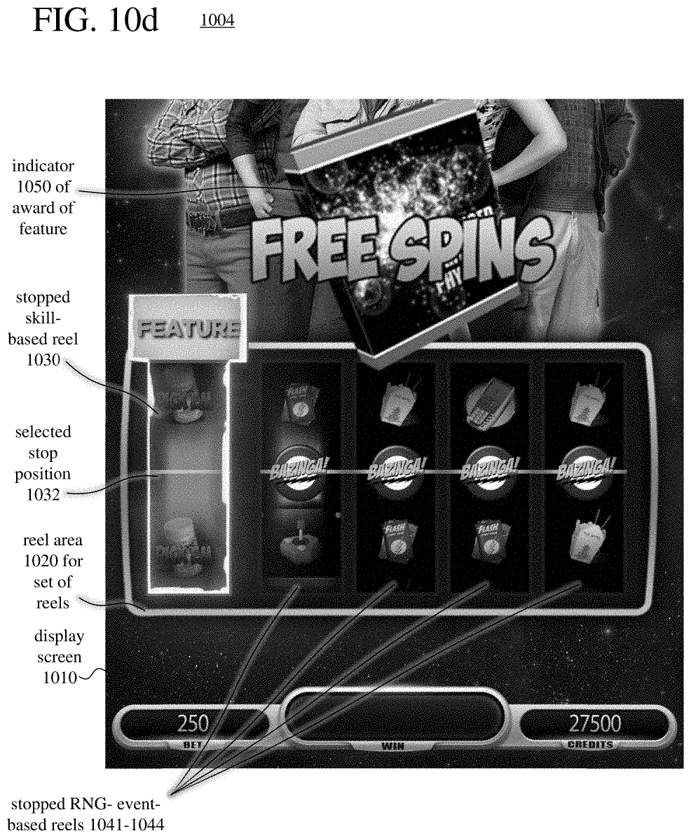

FIGS. 10a-10d show example screenshots 1001-1004 of an electronic gaming device. In the screenshots 1001-1004, the display screen 1010 incudes a reel area 1020 for a set of reels. The reel area is a 5×3 reel area, with five reels and three symbol instances visible per reel. The set of reels includes a skill-based reel 1030 and four RNG-event-based reels 1041-1044. The skill-based reel 1030 is a “pachislo” reel, which the player can try to stop at a desired stop position. The stop positions of the skill-based reel are associated with different game features that can be triggered in a base game. In this example, the game features includes a “pick 'em” feature, a “free spins” feature, a “minor jackpot” feature, and/or other game features.

The screenshot 1001 of FIG. 10a shows the state of the display screen 1010 after the user has placed a bet and started an instance of the base game. The screenshot 1001 shows the skill-based reel 1030 and four RNG-event-based reels 1041-1044 spinning in the reel area 1020.

The screenshot 1002 of FIG. 10b shows the state of the display screen 1010 after the player has stopped the skill-based reel 1030. Specifically, the player has stopped the skill-based reel 1030 at a stop position associated with the “free spins” feature. Thus, the selected stop position 1032 is the “free spins” feature. The other game features shown in the reel area 1020 are not selected. At this point, the four RNG-event-based reels 1041-1044 are still spinning in the reel area 1020.

The RNG-event-based reels 1041-1044 have randomly generated stop positions. The screenshot 1003 of FIG. 10c shows the state of the display screen 1010 after the four RNG-event-based reels 1041-1044 have stopped.

The game feature associated with the selected stop position 1032 might or might not be awarded, depending on results of the RNG-event-based reels 1041-1044. That is, a trigger condition, based on the symbol instances that have landed for the RNG-event-based reels 1041-1044, controls whether the feature is awarded. If the trigger condition is satisfied, the player is awarded the game feature selected in the skill-based reel 1030. If the trigger condition is not satisfied, the player is not awarded the game feature selected in the skill-based reel 1030.

The screenshot 1004 of FIG. 10d shows the state of the display screen 1010 after the trigger condition has been satisfied. Specifically, the reel area 1020 includes four-of-a-kind of a type of symbol, triggering the award of the game feature for the selected stop position 1032. Alternatively, the trigger condition can be, for example, that a threshold count of scatter symbol instances is enclosed in the reel 1020. The display screen 1010 shows an indicator 1050 that the feature has been awarded.

### F. Examples of Integration into Electronic Gaming Devices

Innovations described herein can be implemented in a gaming server 102 and/or gaming device 104A, 104B, 104C, 104X, 200 described with reference to FIGS. 1 and 2. Thus, a gaming server 102 or gaming device 104A, 104B, 104C, 104X, 200 is an example of an electronic gaming device as described in section V.

For example, for the electronic gaming device, a game controller such as a game controller 202 described with reference to FIG. 2 can perform operations described herein. In some implementations, the game controller 202 performs backend operations as well as frontend UI operations. With respect to frontend UI operations, the game controller 202 can receive user input indicating a start to an instance of a process that uses a set of reels and receive user input for skill-based reel(s). Further, the game controller 202 can adjust graphical elements for the process (e.g., reel strips, reel area). The game controller 202 can also control display of indicators of the instance of the process and final outcome. With respect to backend operations, the game controller 202 can start an instance of a process that uses a set of reels, determine whether a result satisfies a trigger condition, and otherwise determine game outcomes.

Innovations described in section V can be implemented in a game processing pipeline that follows the example game processing architecture 300 described with reference to FIG. 3. As described with reference to FIG. 3, conversion engine 320 utilizes one or more lookup tables 322A-322N. In the context of the innovations described herein, for example, one or more of the lookup tables 322A-322N can be used to determine symbol positions at which to stop reel strips and/or to determine other results. In some variations, different lookup tables can be used, so as to adjust the likelihood of specific results depending on bet amount.

In general, the example game processing architecture 300 shown in FIG. 3 can be used to process game play instructions and generate outcomes. In some implementations, the game processing architecture 300 implements a game processing pipeline for a process (e.g., base reel game). The UI system 302 (e.g., the game play UI 304 of the UI system 302) receives user input that indicates a start to an instance of a process that uses a set of reels. The backend system 314 starts an instance of the process. For the instance of the process, the UI system 302 (e.g., the game play UI 304) receives user input for one or more skill-based reels and makes one or more non-RNG calls to the game processing backend system 314 to convey the user input for the skill-based reel(s). The UI system 302 also makes one or more RNG calls to the game processing backend system 314. In response, the backend system 314 performs various operations. The user-input-driven engine 317 maps information from non-RNG calls (such as selections for skill-based reels) to non-RNG outcomes, which are passed to the conversion engine 320. Using a gaming RNG 318, the RNG engine 316 generates one or more random numbers, which are passed to the conversion engine 320. The conversion engine 320, using one or more of the random number(s) and one or more of the lookup tables 322A-322N, and also using the non-RNG calls, performs operations. The backend system 314 can adjust feature (e.g., changing reel strips for the reels) and determine symbol positions at which to stop reel strips for the reels. After determining the symbol positions at which to stop the reel strips for the reels, the backend system 314 determines an outcome (e.g., calculating win conditions for all-ways evaluation). The backend system 314 returns the generated results to the game play UI 304 of the UI system 302, which can, among other operations, change graphical elements for the process and control display of indicators of the instance of the process and final outcome.

In general, the generated results returned by the backend system 314 can include game-related information (such as symbol positions at which to stop reel strips for the respective reels, outcomes) as well as animation effects not related to game parameters. Alternatively, the game play UI 304 can make one or more separate RNG calls to the backend system 314 to determine animation effects. In response, the backend system 314 can use the gaming RNG 318 and/or one or more of the non-gaming RNGs 319A-319N to generate random numbers, which the conversion engine 320 uses (with one or more of the lookup tables 322A-322N) to determine animation effects. The game play UI 304 (or bonus game play UI 308) can perform operations consistent with the animation effects, which are returned from the backend system 314.

### G. Technical Advantages

Approaches described herein address technical problems of allowing a player to select between different ways of implementing volatility for options of a skill-based reel, in an electronic gaming device that includes one or more skill-based reels and one or more RNG-event-based reels. Such approaches can provide different ways to implement a desired level volatility of a base reel game, without significantly deviating from a designated level of RTP for the base reel game.

In terms of system architecture, innovative features described herein provide a way to account for skill-based functionality in an architecture that otherwise only permits RNG-event-based functionality (such as a traditional Class III architecture). For example, whereas a traditional processing pipeline calculates the positions at which one or more RNG-event-based reels are going to be stopped in the future, a processing pipeline according to an improved architecture also accounts for positions at which one or more skill-based reels have already been stopped. The stop positions for the skill-based reel(s) are not determined by RNG, yet they are dynamically selected from the perspective of the processing pipeline, and may require adjustments to how RNG-generated game outcomes are determined in the processing pipeline.

More generally, in terms of technical effects, innovative features of selecting between different ways of implementing volatility for options of a skill-based reel represent improvements in the technical area of electronic gaming software and provide new technology, in that they provide a simple and intuitive way to select how to implement volatility for a designated level of RTP in an electronic gaming device with a mix of skill-based reel(s) and RNG-event-based reel(s). Stated differently, by providing a way for a player to select a desired game feature or desired symbol instances in a skill-based reel, the gameplay mechanic provides the player some control over an outcome. At the same time, game play can be kept fair and consistent with regulations.

For example, a skill-based reel can provide an intuitive way to select and trigger a special mode, bonus reel game, supplemental feature, or other option, which is simple to implement. Other ways to select and trigger an option from a set of possible options include: (1) assigning different types of scatter symbol to the different options and including some or all of the types of scatter symbol in the reel strips; (2) using dynamic symbols to select which type of scatter symbol to utilize for a given instance (e.g., for each spin, the reels randomly select which of the types of scatter symbol to use, thereby limiting which one of the options can be triggered for that spin); and (3) swapping out the reel strips, where different reel strips utilize different types of scatter symbol associated with different options. A skill-based reel provides a simpler way to select an option, without using dynamic symbol resolution or reel strip swapping for types of scatter symbols associated with different options, and without using multiple types of scatter symbol (associated with different options) in reel strips.

At the same time, a skill-based reel can provide an intuitive way to select a special mode, bonus reel game, supplemental feature, or other option, which is consistent with regulations. In an implementation in which options of a skill-based reel have the same RTP, the skill-based reel adds a skill-based selection mechanism without impacting overall RTP for an instance. That is, no matter what option of the skill-based reel is chosen for an instance, the RTP will be the same for the instance. The skill-based selection mechanism thus permits a “user-driven” random outcome that complies with Class III gaming regulations and is comparable to a purely RNG-event-based random outcome. Such a user-driven random outcome differs from skill-based games like video poker, where the skill-based decision-making has some impact on the RTP directly experienced by a player.

In addition, some approaches described herein address the technical problem of controlling volatility for a target level of RTP in an electronic gaming device that includes one or more skill-based reels and one or more RNG-event-based reels, even when the options of the skill-based reel(s) are not balanced with respect to RTP. In particular, in some implementations, adjustments are made to attributes of RNG-event-based reels to compensate for different selections of options in the skill-based reel(s) (which are associated with different levels of RTP), so as to balance overall RTP. In terms of technical effects, innovative features of adjusting attributes of RNG-event-based reels represent improvements in the technical area of electronic gaming software and provide new technology, in that they provide a computationally effective way to manage volatility for a designated level of RTP for an electronic gaming device that includes skill-based reel(s) and RNG-event-based reel(s). As another example, different placement costs (to place options) or different activation costs (to use respective options) can be assigned to different options on a skill-based reel, so as to balance overall RTP. In terms of technical effects, innovative features of adjusting placement costs or activation costs represent improvements in the technical area of electronic gaming software and provide new technology, in that they provide a computationally effective way to achieve a designated level of RTP for an electronic gaming device that includes skill-based reel(s) and RNG-event-based reel(s). Furthermore, by managing lookup tables, placement costs, activation costs and/or other aspects of RNG events for an electronic gaming device that includes skill-based reel(s) and RNG-event-based reel(s), game play can be kept fair and consistent with regulations while also enabling variation of volatility for the designated level of RTP.

Also, UI-focused operations for an electronic gaming device that includes skill-based reel(s) and RNG-event-based reel(s) can improve the usability of electronic gaming devices by enhancing the user experience for players, extending player time on the electronic gaming devices, and maintaining the interest of current players in the electronic gaming devices, whether or not RTP is balanced for different selections of options in the skill-based reel(s).

These embodiments are thus not merely new game rules or new display patterns.

### H. Alternatives with Skill-Like Reels or Pseudo-Skill-Based Reels

In some of the examples described herein, an electronic gaming device with spinning reels includes a mix of one or more skill-based reels and one or more random-event-based reels. Alternatively, instead of having skill-based reels, an electronic gaming device can have one or more skill-like reels or one or more pseudo-skill-based reels.

Skill-like reels. An electronic gaming device with spinning reels can include a mix of one or more skill-like reels and one or more random-event-based reels. For each of the skill-like reel(s), a stop position at which to stop a reel strip for the skill-like reel appears to be determined based on user input, but in fact the skill-like reel is another RNG-event-based reel. That is, for the skill-like reel, a random number is generated using the RNG. Based at least in part on the random number, a stop position at which to stop a reel strip for the skill-like reel is determined. The stopping of the skill-like reel may be triggered by user input (or the expiration of a timer), but the stop position does not depend on the user input or user skill. An outcome of an instance of a process is determined using instances of symbols in a reel area for the stopped RNG-event-based reel(s). The outcome depends on RNG events and does not depend on user input or user skill. Even so, this gameplay mechanic, which appears to combine skill-based decisions for the skill-like reel(s) with RNG-event-based aspects, increases user engagement and interaction with the electronic gaming device.

For example, the skill-like reel is a feature selection reel. That is, the symbol instances of the reel strip for the skill-like reel represent different features such as different special modes, multipliers, supplemental features, or other options. The options represented on the feature selection wheel can be balanced with respect to RTP. In that case, since the options have the same effect on RTP, the feature selection reel can be a skill-based reel or skill-like reel (with a stop position for the skill-like reel being based on an RNG event, but with the stopping of the reel being triggered by user input) without changing the volatility or RTP of the game.

Or, as another example, the skill-like reel is a symbol instance selection reel. That is, the symbol instances of the reel strip for the skill-like reel are the same type of symbol instances as for an RNG-event-based reel.

Pseudo-skill-based reels. Or, as another alternative, an electronic gaming device with spinning reels includes a mix of one or more pseudo-skill-based reels and one or more random-event-based reels. For each of the pseudo-skill-based reel(s), a stop position at which to stop a reel strip for the pseudo-skill-based reel appears to be determined based on user input, but in fact the stop position for the pseudo-skill-based reel depends on both user input and an RNG event. For example, the user input provides the input, or at least part of the input, to an RNG, which generates a random number. Then, based at least in part on the random number, a stop position at which to stop a reel strip for the pseudo-skill-based reel is determined. In this way, the user input can provide a source of entropy for the RNG. The stopping of the pseudo-skill-based reel may be triggered by user input (or the expiration of a timer), but user input or user skill only indirectly affects the stop position due to the intervening RNG event. An outcome of an instance of a process is determined using instances of symbols in a reel area for the stopped RNG-event-based reel(s). The outcome depends on RNG events and does not directly depend on user input or user skill (due to the intervening RNG event). Even so, this gameplay mechanic, which appears to combine skill-based decisions for the pseudo-skill-based reel(s) with RNG-event-based aspects, increases user engagement and interaction with the electronic gaming device.

For example, the pseudo-skill-based reel is a feature selection reel. That is, the symbol instances of the reel strip for the pseudo-skill-based reel represent different features such as different special modes, multipliers, supplemental features, or other options. The options represented on the feature selection wheel can be balanced with respect to RTP. In that case, since the options have the same effect on RTP, the feature selection reel can be a skill-based reel or pseudo-skill-based reel (with the stopping of the pseudo-skill-based reel being triggered by user input and with the user input providing an input for an RNG, but with a stop position being based on an RNG event) without changing the volatility or RTP of the game.

Or, as another example, the pseudo-skill-based reel is a symbol instance selection reel. That is, the symbol instances of the reel strip for the pseudo-skill-based reel are the same type of symbol instances as for an RNG-event-based reel.

### VI. OTHER FEATURES OF ELECTRONIC GAMING DEVICES

A typical electronic gaming device is a specially configured computer system, and not merely a general-purpose computer. For example, one difference between a typical electronic gaming device and common processor-based computer system is that the electronic gaming device is designed to be a state-based system. In a state-based system, the system stores and maintains its current state in non-volatile memory, which can be implemented using battery-backed RAM, flash memory, a solid-state drive, or other persistent memory. Different functions of a game (e.g., bet, play, result, points in the graphical presentation, etc.) may be defined as a state. When a game moves from one state to another, data regarding the game state is stored in a custom non-volatile memory subsystem. In some cases, the gaming device does not advance from a current state to a subsequent state until information that allows the current state to be reconstructed is stored. In the event of a power failure or other malfunction, the gaming device will return to its current state when the power is restored by recovering state information from non-volatile memory. The restored state may include metering information and graphical information that was displayed on the gaming device in the state prior to the malfunction. For instance, if a player was shown an award for a game of chance and, before the award could be provided to the player, the power failed, the gaming device, upon the restoration of power, would return to the state where the award is indicated. More generally, the gaming device records, in non-volatile memory, the values of game parameters assigned during play, such as variables determined by an RNG or internal counters. (A game parameter, in general, can be one or more variables whose values govern play at the gaming device and depend on a random selection process.) The value of a game parameter can be recorded periodically, in response to some event such as user input, or whenever the value of the game parameter changes. This way, the gaming device can recover its state in case of a power failure or “tilt” event, allowing the gaming device to reconstruct events that have taken place before the power failure or “tilt” event. This requirement affects the software and hardware design on a gaming device. Game history information regarding previous games played, such as an amount wagered, the outcome of the game and so forth, may also be stored in a non-volatile memory device.

In the context of the innovations described herein, for example, a game controller 202 can save information about mode for a base reel game, the reel strips in use, the reel area in use, and symbol positions at which to stop reel strips for skill-based reels and/or RNG-event-based reels in non-volatile memory at various stages. The non-volatile memory can also store other state information, such as a current bet amount, an amount of credits remaining, and/or a win amount for a base reel game, bonus reel game and/or other feature. More generally, non-volatile memory can store state information such as positions of the respective reels, in addition to storing information that indicates the configuration of reel strips of the reels. After finishing a feature or a base reel game, the game controller 202 can store information in non-volatile memory that indicates an outcome (e.g., award amount) or status.

### VII. INNOVATIVE FEATURES

Innovative features described herein include, but are not limited to, the following.

| | Feature |
|---|---|
| A1 | A method of integrating a skill-based selection mechanism and a random number |
| | generator (“RNG”)-event-based mechanism in an electronic gaming device, the method |
| | comprising: |
| | starting an instance of a process that uses a set of reels and at least one RNG, the |
| | set of reels including one or more skill-based reels and one or more RNG-event-based |
| | reels; |
| | for each of the one or more skill-based reels, determining a stop position at which |
| | to stop a reel strip for the skill-based reel, the stop position at which to stop the reel strip |
| | for the skill-based reel being based on user input; |
| | for each of the one or more RNG-event-based reels: |
| | generating a random number using the RNG; and |
| | determining, based at least in part on the random number, a stop position |
| | at which to stop a reel strip for the RNG-event-based reel; and |
| | determining, based at least in part on instances of symbols in a reel area for the |
| | one or more stopped RNG-event-based reels, an outcome of the instance of the process. |
| A2 | The method of A1, wherein the determining the stop position at which to stop the |
| | reel strip for the RNG-event-based reel includes performing a lookup operation for the |
| | random number in a lookup table, the lookup table including entries that indicate |
| | different stop positions of the reel strip for the RNG-event-based reel, thereby |
| | determining one of the different stop positions at which to stop the reel strip for the |
| | RNG-event-based reel. |
| A3 | The method of A1, wherein the determining the stop position at which to stop the |
| | reel strip for each of the one or more skill-based reels precedes the generating the |
| | random number for each of the one or more RNG-event-based reels. |
| A4 | The method of A3, further comprising: |
| | for at least one of the one or more RNG-event-based reels, adjusting one or more |
| | of (a) the reel strip for the RNG-event-based reel, (b) a lookup table associated with the |
| | RNG-event-based reel, and (c) how dynamic symbols are resolved for the reel strip for |
| | the RNG-event-based reel, to balance return to player in view of the stop position of the |
| | reel strip for each of the one or more skill-based reels. |
| A5 | The method of A3, wherein, for each of the one or more skill-based reels, |
| | different stop positions of the reel strip for the skill-based reel are balanced with respect |
| | to return to player. |
| A6 | The method of A1, wherein the determining the stop position at which to stop the |
| | reel strip for each of the one or more skill-based reels follows the generating the random |
| | number for each of the one or more RNG-event-based reels. |
| A7 | The method of A6, wherein, for each of the one or more skill-based reels, |
| | different stop positions of the reel strip for the skill-based reel are balanced with respect |
| | to return to player. |
| A8 | The method of A6, further comprising: |
| | for at least one of the one or more RNG-event-based reels, adjusting the reel strip |
| | of the RNG-event-based reel to balance return to player in view of the stop position for |
| | each of the one or more skill-based reels. |
| A9 | The method of A8, wherein the adjusting the reel strip of the RNG-event-based |
| | reel includes adjusting instances of symbols of the reel strip. |
| A10 | The method of A1, wherein the outcome of the instance of the process depends |
| | on satisfaction of a trigger condition, and wherein the trigger condition is (a) a count of |
| | special symbols among the instances of symbols in the reel area for the one or more |
| | stopped RNG-event-based reels or (b) a combination of symbols among the instances of |
| | symbols in the reel area for the one or more stopped RNG-event-based reels. |
| A11 | The method of A1, further comprising adjusting one or more attributes of the one |
| | or more skill-based reels, the one or more attributes including: |
| | (a) rate of spin for at least one of the one or more skill-based reels; |
| | (b) direction of spin for at least one of the one or more skill-based reels; |
| | (c) count of the one or more skill-based reels; |
| | (d) instances of symbols on the reel strip for at least one of the one or more skill- |
| | based reels; |
| | (e) sizes of hit boxes for options on the reel strip for at least one of the one or |
| | more skill-based reels; |
| | (f) whether a “nudge” effect is enabled or disabled for at least one of the one or |
| | more skill-based reels; and |
| | (g) whether one of the set of reels is used as one of the one or more skill-based |
| | reels or used as one of the one or more RNG-event-based reels. |
| A12 | The method of A11, wherein the one or more attributes change depending on one |
| | or more of bet amount, denomination, loyalty reward status, payment of a placement |
| | cost, payment of an activation cost, and a result of a previous instance of the process. |
| A13 | The method of A1, wherein the one or more skill-based reels are enabled or |
| | disabled depending on one or more of bet amount, denomination, and payment of a |
| | placement cost, so as to balance return to player. |
| A14 | The method of A1, wherein the one or more skill-based reels are enabled or |
| | disabled depending on one or more of loyalty reward status and user selection. |
| A15 | The method of A1, further comprising adjusting instances of symbols on the reel |
| | strip for at least one of the one or more skill-based reels, wherein the instances of |
| | symbols on the reel strip for at least one of the one or more skill-based reels vary |
| | depending on one or more of bet amount, denomination, payment of a placement cost, |
| | and payment of an activation cost, so as to balance return to player. |
| A16 | The method of A1, further comprising adjusting instances of symbols on the reel |
| | strip for at least one of the one or more skill-based reels, wherein the instances of |
| | symbols on the reel strip for at least one of the one or more skill-based reels vary |
| | depending on one or more of loyalty reward status and user selection. |
| A17 | The method of A1, wherein an option associated with the stop position of the reel |
| | strip for one of the one or more skill-based reels is made inactive in a subsequent |
| | instance of the process. |
| B1 | A method of integrating a skill-based selection mechanism and a random number |
| | generator (“RNG”)-event-based mechanism in an electronic gaming device, the method |
| | comprising: |
| | receiving user input indicating to start an instance of a process that uses a set of |
| | reels and at least one RNG, the set of reels including one or more skill-based reels and |
| | one or more RNG-event-based reels; |
| | spinning the set of reels; |
| | for each of the one or more skill-based reels: |
| | receiving user input that indicates a stop position at which to stop a reel |
| | strip for the skill-based reel; and |
| | stopping the reel strip for the skill-based reel at the stop position for the |
| | skill-based reel; |
| | for each of the one or more RNG-event-based reels, stopping a reel strip for the |
| | RNG-event-based reel at a stop position that has been determined based at least in part |
| | on a random number generated by the RNG; and |
| | outputting an indicator of an outcome of the instance of the process, the outcome |
| | being based at least in part on instances of symbols in a reel area for the one or more |
| | stopped RNG-event-based reels. |
| B2 | The method of B1, wherein the user input that indicates the stop position at |
| | which to stop the reel strip for the skill-based reel is a button press of a physical button, |
| | touchscreen button, or other virtual button. |
| B3 | The method of B1, wherein the indicator of the outcome of the instance of the |
| | process is a graphical indicator for an event associated with the stop position of the reel |
| | strip for one of the one or more skill-based reels. |
| B4 | The method of B1, wherein the indicator of the outcome of the instance of the |
| | process is a graphical indicator for a win amount. |
| B5 | The method of B1, wherein the stopping the reel strip for each of the one or more |
| | skill-based reels precedes the stopping the reel strip for each of the one or more RNG- |
| | event-based reels. |
| B6 | The method of B1, wherein the stopping the reel strip for each of the one or more |
| | skill-based reels follows the stopping the reel strip for each of the one or more RNG- |
| | event-based reels. |
| B7 | The method of B1, further comprising adjusting how the one or more skill-based |
| | reels are graphically depicting by adjusting one or more of: |
| | (a) rate of spin for at least one of the one or more skill-based reels; |
| | (b) direction of spin for at least one of the one or more skill-based reels; |
| | (c) instances of symbols on the reel strip for at least one of the one or more skill- |
| | based reels; |
| | (d) sizes of hit boxes for options on the reel strip for at least one of the one or |
| | more skill-based reels; and |
| | (e) whether a “nudge” effect is enabled or disabled for at least one of the one or |
| | more skill-based reels. |
| B8 | The method of B1, wherein a game feature associated with the stop position of |
| | the reel strip for one of the one or more skill-based reels is indicated to be inactive in a |
| | subsequent instance of the process. |
| AB1 | The method of any one of A1-A15 and B1-B8, wherein reels of the set of reels |
| | are video reels on a display of the electronic gaming device. |
| AB2 | The method of any one of A1-A15 and B1-B8, wherein reels of the set of reels |
| | are physical reels of the electronic gaming device. |
| AB3 | The method of any one of A1-A15 and B1-B8, wherein, for one of the one or |
| | more skill-based reels, different stop positions on the reel strip for the skill-based reel |
| | indicate: |
| | options for types of supplemental feature, wherein the stop position for a given |
| | one of the one or more skill-based reels indicates one of the types of supplemental |
| | feature, the supplemental feature being triggered depending on a combination of |
| | instances of symbols among the instances of symbols in the reel area for the one or more |
| | stopped RNG-event-based reels; |
| | options for types of special mode, wherein the stop position for a given one of |
| | the one or more skill-based reels indicates one of the types of special mode, the special |
| | mode being triggered depending on a combination of instances of symbols among the |
| | instances of symbols in the reel area for the one or more stopped RNG-event-based |
| | reels; |
| | options for available reel strips for at least one of the one or more RNG-event- |
| | based reels, wherein the stop position for a given one of the one or more skill-based reels |
| | indicates one of the available reel strips to use as the reel strip for at least one of the one |
| | or more RNG-event-based reels; or |
| | options for types of conversions to apply to the reel strip for at least one of the |
| | RNG-event-based reels, wherein the stop position for a given one of the one or more |
| | skill-based reels indicates one of the types of conversions to apply to the reel strip for at |
| | least one of the RNG-event-based reels. |
| AB4 | The method of any one of A1-A15 and B1-B8, wherein for one of the one or |
| | more skill-based reels, different positions on the reel strip for the skill-based reel |
| | indicate: |
| | one or more options for types of a supplemental feature or special mode; |
| | one or more options for a trigger condition for the supplemental feature or special |
| | mode; |
| | one or more options for a re-trigger of the supplemental feature or special mode; |
| | one or more options for number of free games or free spins; |
| | one or more options for a multiplier; |
| | one or more options for an award of credits; |
| | one or more options for instances of symbols that can count towards winning |
| | combinations along paylines; and/or |
| | one or more options for instances of credit symbols. |
| AB5 | The method of any one of A1-A15 and B1-B8, wherein, for one of the one or |
| | more skill-based reels, different positions on the reel strip for the skill-based reel |
| | indicate instances of symbols, the outcome being further based at least in part on |
| | instances of symbols in the reel area for the one or more stopped skill-based reels. |
| AB6 | The method of any one of A1-A15 and B1-B8, wherein the one or more skill- |
| | based reels are positioned starting at one side of the reel area and continuing across the |
| | reel area, the one or more RNG-event-based reels being positioned following the one or |
| | more skill-based reels across the reel area. |
| AB7 | The method of any one of A1-A15 and B1-B8, wherein the one or more skill- |
| | based reels include multiple skill-based reels, and wherein the multiple skill-based reels |
| | are positioned at different sides of the reel area, the one or more RNG-event-based reels |
| | being positioned between the multiple skill-based reels. |
| AB8 | The method of any one of A1-A15 and B1-B8, wherein each of the one or more |
| | skill-based reels is positioned at a random location in the reel area for the instance of the |
| | process. |
| AB9 | The method of any one of A1-A15 and B1-B8, wherein, for one of the one or |
| | more skill-based reels, different positions on the reel strip for the skill-based reel |
| | indicate options that depend on one or more of bet amount, denomination, and loyalty |
| | reward status. |
| AB10 | The method of any one of A1-A15 and B1-B8, wherein, for one of the one or |
| | more skill-based reels, different positions on the reel strip for the skill-based reel |
| | indicate options that depend on a result of a previous instance of the process. |
| AB11 | The method of any one of A1-A15 and B1-B8, wherein at least one of the one or |
| | more skill-based reels is a feature selection reel. |
| AB12 | The method of AB11, wherein the outcome of the instance of the process is |
| | whether or not a game feature is activated, the game feature being associated with the |
| | stop position of the reel strip for a given one of the one or more skill-based reels. |
| AB13 | The method of AB11, wherein the stop position is associated with a game feature |
| | centered within the reel area for a given one of the one or more skill-based reels. |
| AB14 | The method of any one of A1-A15 and B1-B8, wherein at least one of the one or |
| | more skill-based reels is a symbol instance selection reel. |
| AB15 | 36. The method of AB14, wherein the outcome of the instance of the process |
| | depends on win conditions for combination of instances of symbols along possible paths |
| | through active symbol display positions of the reel area, wherein, for each of the |
| | possible paths through the active symbol display positions of the reel area, the possible |
| | path uses one of the instances of symbols per reel and crosses the reel area from one side |
| | of the reel area to an opposite side of the reel area. |
| AB16 | A computer system comprising one or more processors and memory readable by |
| | the one or more processors, the memory having stored thereon computer-executable |
| | instructions for causing the one or more processors, when programmed thereby, to |
| | perform operations for the method of any one of A1-A15, B1-B8, and AB1-AB15. |
| AB17 | One or more non-transitory computer-readable media having stored thereon |
| | computer-executable instructions for causing one or more processors, when programmed |
| | thereby, to perform operations for the method of any one of A1-A15, B1-B8, and AB1- |
| | AB15. |

### VIII. ALTERNATIVES AND VARIATIONS

Numerous embodiments are described in this disclosure, and are presented for illustrative purposes only. The described embodiments are not, and are not intended to be, limiting in any sense. The present disclosure is widely applicable to numerous embodiments, as is readily apparent from the disclosure. One of ordinary skill in the art will recognize that the innovations described herein may be practiced with various modifications and alterations, such as structural, logical, software, and electrical modifications. Although particular features of the innovations described herein may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the innovations described herein that must be present in all embodiments.

The Title (set forth at the beginning of the first page of this disclosure) is not to be taken as limiting in any way as the scope of the disclosed embodiments. Headings of sections provided in this disclosure are for convenience only, and are not to be taken as limiting the disclosure in any way.

When an ordinal number (such as “first,” “second,” “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget.” Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When introducing elements of aspects of the present disclosure or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

When a single device, component, structure, or article is described herein, more than one device, component, structure or article (whether or not they cooperate) may alternatively be used in place of the single device, component or article that is described. Accordingly, the functionality that is described as being possessed by a device may alternatively be possessed by more than one device, component or article (whether or not they cooperate).

Similarly, where more than one device, component, structure, or article is described herein (whether or not they cooperate), a single device, component, structure, or article may alternatively be used in place of the more than one device, component, structure, or article that is described. For example, a plurality of computer-based devices may be substituted with a single computer-based device. Accordingly, the various functionality that is described as being possessed by more than one device, component, structure, or article may alternatively be possessed by a single device, component, structure, or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Further, the systems and methods described herein are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the innovations described herein. Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the innovations described herein, and does not imply that the illustrated process is preferred.

Although a process may be described as including a plurality of steps, that does not indicate that all or even any of the steps are essential or required. Various other embodiments within the scope of the present disclosure include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the present disclosure include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise.

For the sake of presentation, the detailed description uses terms like “determine” and “select” to describe computer operations in a computer system. These terms denote operations performed by a computer, and should not be confused with acts performed by a human being. The actual computer operations corresponding to these terms vary depending on implementation. For example, “determining” something can be performed in a variety of manners, and therefore the term “determining” (and like terms) can indicate calculating, computing, deriving, looking up (e.g., in a table, database or data structure), ascertaining, recognizing, and the like.

As used herein, the term “send” denotes any way of conveying information from one component to another component, and the term “receive” denotes any way of getting information at one component from another component. The two components can be part of the same computer system or different computer systems. The information can be passed by value (e.g., as a parameter of a message or function call) or passed by reference (e.g., in a buffer). Depending on context, the information can be communicated directly between the two components or be conveyed through one or more intermediate components. As used herein, the term “connected” denotes an operable communication link between two components, which can be part of the same computer system or different computer systems. The operable communication link can be a wired or wireless network connection, which can be direct or pass through one or more intermediate components (e.g., of a network). Communication among computers and devices may be encrypted to insure privacy and prevent fraud in any of a variety of ways well known in the art.

It will be readily apparent that the various methods and algorithms described herein may be implemented by, e.g., appropriately programmed general-purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium for performing the process. The apparatus that performs the process can include components and devices (e.g., a processor, input and output devices) appropriate to perform the process. A computer-readable medium can store program elements appropriate to perform the method.

The term “computer-readable medium” refers to any non-transitory storage or memory that may store computer-executable instructions or other data in a computer system and be read by a processor in the computer system. A computer-readable medium may take many forms, including but not limited to non-volatile storage or memory (such as optical or magnetic disk media, a solid-state drive, a flash drive, PROM, EPROM, and other persistent memory) and volatile memory (such as DRAM). The term “computer-readable media” excludes signals, waves, and wave forms or other intangible or transitory media that may nevertheless be readable by a computer.

The present disclosure provides, to one of ordinary skill in the art, an enabling description of several embodiments and/or innovations. Some of these embodiments and/or innovations may not be claimed in the present application, but may nevertheless be claimed in one or more continuing applications that claim the benefit of priority of the present application. Applicants may file additional applications to pursue patents for subject matter that has been disclosed and enabled but not claimed in the present application.

The foregoing description discloses only exemplary embodiments of the present disclosure. Modifications of the above disclosed apparatus and methods which fall within the scope of the present disclosure will be readily apparent to those of ordinary skill in the art. For example, although the examples discussed above are illustrated for a gaming market, embodiments of the present disclosure can be implemented for other markets. The gaming system environment of the examples is not intended to suggest any limitation as to the scope of use or functionality of any aspect of the disclosure.

While the invention has been described with respect to the figures, it will be appreciated that many modifications and changes may be made by those skilled in the art without departing from the spirit of the invention. Any variation and derivation from the above description and figures are included in the scope of the present invention as defined by the claims. In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computer system comprising one or more processors and memory readable by the one or more processors, the memory having stored thereon computer-executable instructions for causing the one or more processors, when programmed thereby, to perform operations to integrate a skill-based selection mechanism and a random number generator (“RNG”)-event-based mechanism in an electronic gaming device, the operations comprising:
starting an instance of a process that uses a set of reels and at least one RNG, the set of reels including one or more skill-based reels and one or more RNG-event-based reels;
for each of the one or more skill-based reels, determining a stop position at which to stop a reel strip for the skill-based reel, the stop position at which to stop the reel strip for the skill-based reel being based on user input;
for each of the one or more RNG-event-based reels:
generating a random number using the RNG; and
determining, based at least in part on the random number, a stop position at which to stop a reel strip for the RNG-event-based reel; and
determining, based at least in part on instances of symbols in a reel area for the one or more stopped RNG-event-based reels, an outcome of the instance of the process.

2. The computer system of claim 1, wherein the determining the stop position at which to stop the reel strip for each of the one or more skill-based reels precedes the generating the random number for each of the one or more RNG-event-based reels, the operations further comprising:
for at least one of the one or more RNG-event-based reels, adjusting one or more of (a) the reel strip for the RNG-event-based reel, (b) a lookup table associated with the RNG-event-based reel, and (c) how dynamic symbols are resolved for the reel strip for the RNG-event-based reel, to balance return to player in view of the stop position of the reel strip for each of the one or more skill-based reels.

3. The computer system of claim 1, wherein the determining the stop position at which to stop the reel strip for each of the one or more skill-based reels precedes or follows the generating the random number for each of the one or more RNG-event-based reels, and wherein, for each of the one or more skill-based reels, different stop positions of the reel strip for the skill-based reel are balanced with respect to return to player.

4. The computer system of claim 1, wherein the determining the stop position at which to stop the reel strip for each of the one or more skill-based reels follows the generating the random number for each of the one or more RNG-event-based reels, the operations further comprising:
for at least one of the one or more RNG-event-based reels, adjusting the reel strip of the RNG-event-based reel to balance return to player in view of the stop position for each of the one or more skill-based reels.

5. The computer system of claim 1, wherein the operations further comprise adjusting one or more attributes of the one or more skill-based reels, the one or more attributes including:
(a) rate of spin for at least one of the one or more skill-based reels;
(b) direction of spin for at least one of the one or more skill-based reels;
(c) count of the one or more skill-based reels;
(d) instances of symbols on the reel strip for at least one of the one or more skill-based reels;
(e) sizes of hit boxes for options on the reel strip for at least one of the one or more skill-based reels;
(f) whether a “nudge” effect is enabled or disabled for at least one of the one or more skill-based reels; and
(g) whether one of the set of reels is used as one of the one or more skill-based reels or used as one of the one or more RNG-event-based reels.

6. The computer system of claim 5, wherein the one or more attributes change depending on one or more of bet amount, denomination, loyalty reward status, and a result of a previous instance of the process.

7. The computer system of claim 1, wherein an option associated with the stop position of the reel strip for one of the one or more skill-based reels is made inactive in a subsequent instance of the process.

8. The computer system of claim 1, wherein, for one of the one or more skill-based reels, different stop positions on the reel strip for the skill-based reel indicate:
options for types of supplemental feature, wherein the stop position for a given one of the one or more skill-based reels indicates one of the types of supplemental feature, the supplemental feature being triggered depending on a combination of instances of symbols among the instances of symbols in the reel area for the one or more stopped RNG-event-based reels;
options for types of special mode, wherein the stop position for a given one of the one or more skill-based reels indicates one of the types of special mode, the special mode being triggered depending on a combination of instances of symbols among the instances of symbols in the reel area for the one or more stopped RNG-event-based reels;
options for available reel strips for at least one of the one or more RNG-event-based reels, wherein the stop position for a given one of the one or more skill-based reels indicates one of the available reel strips to use as the reel strip for at least one of the one or more RNG-event-based reels; or
options for types of conversions to apply to the reel strip for at least one of the RNG-event-based reels, wherein the stop position for a given one of the one or more skill-based reels indicates one of the types of conversions to apply to the reel strip for at least one of the RNG-event-based reels.

9. The computer system of claim 1, wherein for one of the one or more skill-based reels, different positions on the reel strip for the skill-based reel indicate:
one or more options for types of a supplemental feature or special mode;
one or more options for a trigger condition for the supplemental feature or special mode;
one or more options for a re-trigger of the supplemental feature or special mode;
one or more options for number of free games or free spins;
one or more options for a multiplier;
one or more options for an award of credits;
one or more options for instances of symbols that can count towards winning combinations along paylines; and/or
one or more options for instances of credit symbols.

10. The computer system of claim 1, wherein, for one of the one or more skill-based reels, different positions on the reel strip for the skill-based reel indicate instances of symbols, the outcome being further based at least in part on instances of symbols in the reel area for the one or more stopped skill-based reels.

11. The computer system of claim 1, wherein the one or more skill-based reels are enabled or disabled depending on one or more of:
bet amount, denomination, and payment of a placement cost, so as to balance return to player; or
loyalty reward status and user selection.

12. The computer system of claim 1, wherein the operations further comprise adjusting instances of symbols on the reel strip for at least one of the one or more skill-based reels, wherein the instances of symbols on the reel strip for at least one of the one or more skill-based reels vary depending on one or more of:
bet amount, denomination, payment of a placement cost, and payment of an activation cost, so as to balance return to player; or
loyalty reward status and user selection.

13. A method of integrating a skill-based selection mechanism and a random number generator (“RNG”)-event-based mechanism in an electronic gaming device, the method comprising:
starting an instance of a process that uses a set of reels and at least one RNG, the set of reels including one or more skill-based reels and one or more RNG-event-based reels;
adjusting one or more attributes of the one or more skill-based reels, wherein the one or more attributes change depending on one or more of bet amount, denomination, payment of a placement cost, and payment of an activation cost, so as to balance return to player;
for each of the one or more skill-based reels, determining a stop position at which to stop a reel strip for the skill-based reel, the stop position at which to stop the reel strip for the skill-based reel being based on user input;
for each of the one or more RNG-event-based reels:
generating a random number using the RNG; and
determining, based at least in part on the random number, a stop position at which to stop a reel strip for the RNG-event-based reel; and
determining, based at least in part on instances of symbols in a reel area for the one or more stopped RNG-event-based reels, an outcome of the instance of the process.

14. One or more non-transitory computer-readable media having stored thereon computer-executable instructions for causing one or more processors, when programmed thereby, to perform operations to integrate a skill-based selection mechanism and a random number generator (“RNG”)-event-based mechanism in an electronic gaming device, the operations comprising:
receiving user input indicating to start an instance of a process that uses a set of reels and at least one random number generator (“RNG”), the set of reels including one or more skill-based reels and one or more RNG-event-based reels;
spinning the set of reels;
for each of the one or more skill-based reels:
receiving user input that indicates a stop position at which to stop a reel strip for the skill-based reel; and
stopping the reel strip for the skill-based reel at the stop position for the skill-based reel;
for each of the one or more RNG-event-based reels, stopping a reel strip for the RNG-event-based reel at a stop position that has been determined based at least in part on a random number generated by the RNG; and
outputting an indicator of an outcome of the instance of the process, the outcome being based at least in part on instances of symbols in a reel area for the one or more stopped RNG-event-based reels.

15. The one or more non-transitory computer-readable media of claim 14, wherein the user input that indicates the stop position at which to stop the reel strip for the skill-based reel is a button press of a physical button, touchscreen button, or other virtual button.

16. The one or more non-transitory computer-readable media of claim 14, wherein the indicator of the outcome of the instance of the process is:
a graphical indicator for an event associated with the stop position of the reel strip for one of the one or more skill-based reels; or
a graphical indicator for a win amount.

17. The one or more non-transitory computer-readable media of claim 14, further comprising adjusting how the one or more skill-based reels are graphically depicting by adjusting one or more of:
(a) rate of spin for at least one of the one or more skill-based reels;
(b) direction of spin for at least one of the one or more skill-based reels;
(c) instances of symbols on the reel strip for at least one of the one or more skill-based reels;
(d) sizes of hit boxes for options on the reel strip for at least one of the one or more skill-based reels; and
(e) whether a “nudge” effect is enabled or disabled for at least one of the one or more skill-based reels.

18. The one or more non-transitory computer-readable media of claim 14, wherein the one or more skill-based reels are positioned starting at one side of the reel area and continuing across the reel area, the one or more RNG-event-based reels being positioned following the one or more skill-based reels across the reel area.

19. The one or more non-transitory computer-readable media of claim 14, wherein at least one of the one or more skill-based reels is a feature selection reel, and wherein the outcome of the instance of the process is whether or not a game feature is activated, the game feature being associated with the stop position of the reel strip for a given one of the one or more skill-based reels.

20. The one or more non-transitory computer-readable media of claim 14, wherein at least one of the one or more skill-based reels is a symbol instance selection reel, wherein the outcome of the instance of the process depends on win conditions for combination of instances of symbols along possible paths through active symbol display positions of the reel area, and wherein, for each of the possible paths through the active symbol display positions of the reel area, the possible path uses one of the instances of symbols per reel and crosses the reel area from one side of the reel area to an opposite side of the reel area.
